(19) United States
(12) Patent Application Publication
(10) Pub. No.: US 2017/0329635 A1
(43) Pub. Date: Nov. 16, 2017

(54) SYSTEMS AND METHODS FOR DISTRIBUTED COMPUTING

(71) Applicant: University of Utah Research Foundation, Salt Lake City, UT (US)

(72) Inventor: Nicholas Rathke, Salt Lake City, UT (US)

(21) Appl. No.: 15/593,082

(22) Filed: May 11, 2017

Related U.S. Application Data
(60) Provisional application No. 62/336,570, filed on May 13, 2016.

(51) Int. Cl. G06F 9/48; G06F 17/50

(52) U.S. Cl. CPC G06F 9/4887; G06F 17/5009

(57) ABSTRACT

A distributed computing manager provides access to computing resources of a plurality of separate computing systems. The distributed computing manager emulates the distributed computing resources as a unitary computing system comprising an emulated processor, I/O, memory, and so on. The distributed computing manager distributes instructions, I/O requests, memory accesses, and the like, to respective computing systems, which emulate execution on any suitable computing platform. The distributed computing manager may be hardware agnostic and, as such, may not rely on proprietary virtualization infrastructure.

### RELATED APPLICATIONS

This application claims priority to U.S. Provisional Patent Application No. 62/336,570 entitled “Systems and Methods for Distributed Computing,” which was filed on May 13, 2016, and which is hereby incorporated by reference herein.

### TECHNICAL FIELD

This disclosure relates to systems and methods for distributed computing and, more particularly, to systems and methods for emulating a distributed computing environment that spans a plurality of distributed computing systems as a unitary computing system.

### BACKGROUND

Distributed application computing environments enable highly-complex computing tasks to be executed on a plurality of different computing devices. However, current implementations often require proprietary hardware and may force application developers to customize computing tasks for specific distributed computing environments. Disclosed herein are systems and methods to provide a distributed computing environment that is hardware agnostic and that does not require extensive application customization.

### SUMMARY

Disclosed herein are systems and methods for a distributed computing environment. As disclosed herein, a system for distributed computing may comprise a cluster comprising a plurality of computing devices, each computing device comprising a respective processor and memory and being communicatively coupled to an interconnect, a distributed computing manager configured for operation on a first one of the plurality of computing devices, the distributed computing manager configured to manage emulated computing resources of a host computing environment, the emulated computing resources comprising an emulated processor, a distributed execution scheduler configured to receive instructions for emulated execution on an emulated processor, and to assign the instructions to two or more of the plurality of computing devices, a metadata synchronization engine to synchronize an operating state of the emulated processor between the two or more computing devices during emulated execution of the instructions on the two or more computing devices. The distributed computing manager may be configured to provide a host environment comprising emulated computing resources that correspond to physical computing resources of a plurality of computing devices in the cluster.

The system may further comprise an execution scheduler configured to assign the instructions to respective computing devices in the cluster based on emulated computing resources referenced by the instructions. The emulated computing resources may include a distributed memory space comprising emulated memory addresses that translate to respective physical memory addresses of the computing devices, and the execution scheduler may be configured to assign an instruction to a particular computing device in response to determining that an emulated memory address referenced by the first instruction translates to a physical memory address of the particular computing device. In some embodiments, the emulated computing resources may include emulated I/O resources that correspond to respective physical I/O resources of the computing devices, and the execution scheduler may be configured to assign an instruction to a particular computing device in response to determining that an emulated I/O resource of the instruction corresponds to a physical I/O resource of the particular computing device.

The distributed computing manager may be configured to maintain translations between the emulated computing resources and addresses to corresponding physical computing resources of the computing devices, and the execution scheduler may be configured to assign instructions to the two or more computing devices based on translations between emulated computing resources referenced by the instructions and the addresses to the corresponding physical resources of the computing devices. The synchronization engine may be configured to synchronize distributed processor emulation metadata between the two or more computing devices, the distributed processor emulation metadata defining a same operating state of the emulated processor, such that each of the two or more computing devices emulates execution of the instructions according to the same operating state of the emulated processor. The distributed processor emulation metadata may define one or more of an architecture of the emulated processor, a configuration of the emulated processor, and an operating state of the emulated processor. Alternatively, or in addition, the distributed processor emulation metadata may define one or more of data storage of the emulated processor, an operating state of a structural element of the emulated processor, and an operating state of a control element of the emulated processor.

The metadata synchronization engine may be configured to identify a portion of the distributed processor emulation metadata to be accessed during emulated execution of an instruction assigned to a computing device and to lock the identified portion for access by the computing device during emulated execution of the instruction by the computing device.

The systems and methods disclosed herein may comprise providing emulated computing resources to a guest application, wherein the emulated computing resources correspond to physical computing resources of respective compute nodes, the emulated computing resources comprising an emulated processor, receiving instructions of the guest application for execution on the emulated processor, and assigning the instructions for execution on the emulated processor at respective compute nodes. Assigning an instruction to a particular compute node may comprise, identifying one or more emulated computing resources referenced by the instruction, determining translations between the emulated computing resources referenced by the instruction and physical computing resources of the compute nodes, and assigning the instruction to the particular compute node based on the determined translations. Identifying the one or more emulated computing resources referenced by the instruction may comprise decompiling the instruction. Alternatively, or in addition, identifying the one or more emulated computing resources referenced by the instruction may comprise determining one or more opcodes corresponding to the instruction.

The emulated computing resources referenced by the instruction may comprise an address of an emulated memory address space, and determining the translations may comprise mapping the address of the emulated memory address space to a physical memory resource of one or more of the compute nodes. In another embodiment, the emulated computing resources referenced by the instruction may comprise an identifier of an emulated I/O resource, and determining the translations may comprise translating the identifier of the emulated I/O resource to a local I/O resource of one of the compute nodes.

The disclosed systems and methods may further include monitoring compute operations implemented by the compute nodes to determine one or more metrics for the respective compute nodes, and assigning instruction to the particular compute node based on the determined translations and the determined metrics of the respective compute nodes. The metric determined for a compute node may comprise one or more of a performance metric that quantifies one or more performance characteristics of the compute node, a load metric that quantifies a load on physical computing resources of the compute node, and a health metric that quantifies a health of the compute node.

In some embodiments, the disclosed systems and methods include synchronizing processor emulation metadata between the compute nodes, such that each of the compute nodes emulates instruction execution based on a synchronized operating state of the emulated processor. Synchronizing the processor emulation metadata may comprise synchronizing one or more of register state metadata for the emulated processor, structural state metadata for the emulated processor, and control state metadata for the emulated processor. Emulating execution of an instruction on the emulated processor at a compute node may comprise, identifying a portion of the processor emulation metadata to be read during emulated execution of the instruction, and acquiring a read lock on the portion of processor emulation metadata during emulated execution of the instruction at the compute node. The read lock may be released in response to completing the emulated execution of the instruction at the compute node. In some embodiments, emulating execution of an instruction on the emulated processor at a compute node may comprise, identifying a portion of the processor emulation metadata to be modified during emulated execution of the instruction, and acquiring a write lock on the portion of processor emulation metadata prior to emulating execution of the instruction at the compute node. The instruction may be emulated in response to acquiring the write lock. The write lock may be released in response to determining that emulated execution of the instruction has been completed at the compute node. Alternatively, or in addition, the write lock may be released in response to synchronizing a modification to the portion of the processor emulation metadata to one or more other compute nodes.

Emulating execution of an instruction at a compute node may include analyzing the instruction to determine a lock required to maintain consistency of the processor emulation metadata during concurrent emulation of instructions on the emulated processor by one or more other compute nodes, and emulating execution of the instruction at the compute node in response to acquiring the determined lock. Analyzing the instruction may comprise identifying one or more accesses to the processor emulation metadata required for emulated execution of the instruction. Identifying the one or more accesses may comprise pre-emulating the instruction by use of the synchronized processor emulation metadata at the compute node. The pre-emulation may include identifying one or more of a potential data hazard, a potential structural hazard, and a potential control hazard based on the one or more identified accesses. In some embodiments, determining the lock required to maintain consistency of the processor emulation metadata may comprise determining a lock to prevent one or more of a potential data hazard, a potential structural hazard, and a potential control hazard.

### BRIEF DESCRIPTION OF THE DRAWINGS

FIG. 1 is a schematic block diagram of one embodiment of a distributed computing environment;

FIG. 2 is a schematic block diagram of another embodiment of a distributed computing environment;

FIG. 3 is a schematic block diagram of one embodiment of a distributed execution manager;

FIG. 4 is a schematic block diagram of another embodiment of a distributed execution manager;

FIG. 5A is a schematic block diagram of one embodiment of a distributed computing manager to manage distributed I/O;

FIG. 5B is a schematic block diagram of one embodiment of distributed I/O metadata;

FIG. 5C is a schematic block diagram of one embodiment of distributed storage metadata;

FIG. 5D is a schematic block diagram of another embodiment of distributed storage metadata;

FIG. 6A is a schematic block diagram of one embodiment of a distributed computing manager to manage distributed memory;

FIG. 6B is a schematic block diagram of one embodiment of distributed memory metadata;

FIG. 7 is a schematic block diagram of one embodiment of a distributed emulation crossbar switch;

FIG. 8 is a schematic block diagram of another embodiment of a distributed emulation crossbar switch;

FIG. 9 is a flow diagram of one embodiment of a method for distributed computing;

FIG. 10 is a flow diagram of one embodiment of a method for providing a distributed computing environment;

FIG. 11 is a flow diagram of one embodiment of a method for managing a distributed computing environment; and

FIG. 12 is a flow diagram of another embodiment of a method for managing a distributed computing environment.

### DETAILED DESCRIPTION OF PREFERRED EMBODIMENTS

Disclosed herein are embodiments of systems and methods for providing a computing environment for distributed application execution. Embodiments of the computing environment disclosed herein may be configured to distribute execution of an application over a plurality of different computing systems and/or using a plurality of different, distributed computing resources. The computing environment disclosed herein may be managed by a distributed computing service, which may be configured to manage virtualized and/or emulated computing resources for applications hosted thereby. The distributed computing service may comprise a distributed computing manager (DCM) configured for operation on a computing device. The DEM may be configured for operation on any suitable computing hardware and may not rely on proprietary hardware support, such as proprietary network infrastructure, proprietary shared memory infrastructure, a particular processor instruction set (e.g., virtualization instruction set), and/or the like. Accordingly, the distributed computing environment disclosed herein may be referred to as “hardware agnostic.” The distributed computing environment disclosed herein may, for example, be configured to emulate any suitable computing environment, and may distribute operations thereof to a plurality of different computing systems, each of which may be configured to emulate the computing environment.

As used herein, an “application” refers to computer-readable instructions configured for execution within a computing environment. An application may comprise an operating system, a user application, a particular set of processing tasks, and/or the like. As used herein, “hosting” an application refers to providing an execution environment configured to service computing operations thereof. Hosting an application in a virtualized and/or emulated computing environment may, therefore, comprise servicing requests directed to emulated computing resources using physical computing resources of a plurality of different computing systems. As used herein, emulated computing resources may include, but are not limited to: processing resources, memory resources, input/output (I/O) resources, storage resources, and the like. The emulated computing resources managed by the distributed computing manager may correspond to physical computing resources of a plurality of different computing systems. As used herein, a “physical computing resource” or “bare metal computing resource” refers to physical computing hardware and/or firmware, such as a processor, a volatile memory device, a non-volatile storage device, an I/O bus, an I/O device, and/or the like. The distributed computing manager may be configured to manage physical computing resources of a plurality of computing systems and may provide access to the physical computing resources through an emulation layer of a host computing environment. The distributed computing manager may be further configured to emulate a particular computing environment. As disclosed in further detail herein, the distributed computing manager may be configured to emulate a single computing system that spans multiple physical computing systems.

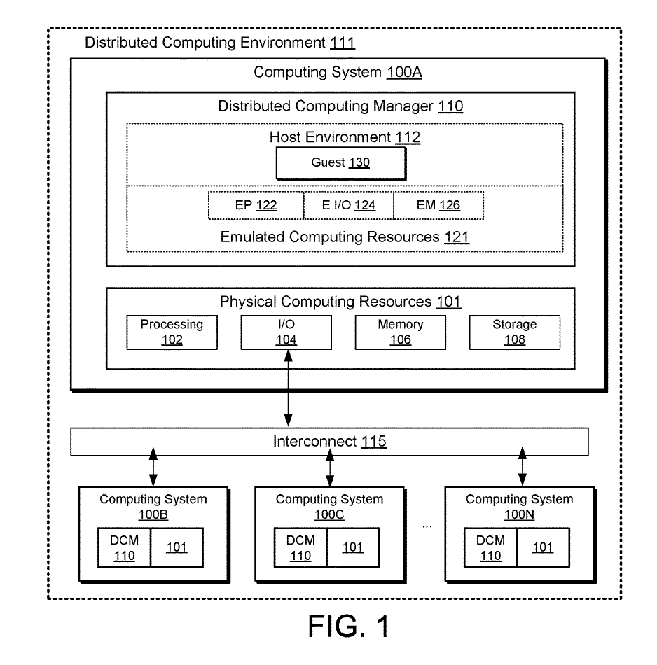

FIG. 1 is a schematic block diagram of one embodiment of a distributed computing environment 111 comprising a plurality of computing systems 100A-N. As disclosed herein, the computing systems 100A-N may be communicatively coupled to one another and may be configured to cooperatively operate to implement distributed computing operations. Accordingly, the distributed computing environment 111 may be referred to as comprising a “cluster” of computing systems 100A-N. Each computing system 100A-N may comprise a respective set of physical computing resources 101. In the FIG. 1 embodiment, the computing system 100A comprises a distributed computing manager (DCM) 110. As disclosed in further detail herein, the DCM 110 may be configured to provide a virtualized and/or emulated computing environment for applications, such as a guest 130. Computing operations within the provided environment may be transparently distributed to the computing systems 100A-N for execution by use of respective physical computing resources 101 thereof.

The physical computing resources 101 of the computing system 100A may include, but are not limited to: processing resources 102, I/O resources 104, memory resources 106, storage resources 108, and/or the like. The processing resources 102 may comprise one or more processing units and/or processing cores. The processing resources 102 may include, but are not limited to: a general-purpose processor, a central processing unit (CPU), a multi-core CPU, a special-purpose processor, an Application Specific Integrated Circuit (ASIC), a programmable circuit, a programmable array logic (PAL) circuit, a Field Programmable Logic Array (FPLA) circuit, a Field Programmable Gate Array (FPGA), and/or the like. The processing resources 102 may comprise one or more processing cores capable of independently decoding and executing instructions.

The I/O resources 104 of the computing system 100A may comprise hardware, software, and/or firmware configured to manage communication between the physical computing resources 101 and/or entities external to the computing system 100A, such as remote computing systems 100B-N. The I/O resources 104 may include, but are not limited to: a front-side bus (FSB) and/or back-side bus to communicatively couple the processing resources 102 to the memory resources 106 and/or I/O devices, a host bridge, a Northbridge, a Southbridge, a system bus, an Accelerated Graphics Port (AGP) channel, an I/O controller, an I/O bus, a peripheral component interconnect (PCI) bus, a PCI Express bus (PCIe), a Serial Advanced Technology Attachment (serial ATA) bus, a universal serial bus (USB) controller, an Institute of Electrical and Electronics Engineers (IEEE) 1394 bus, a network interface to communicatively couple the computing system 100A to an interconnect 115, and/or the like. The interconnect 115 may be configured to communicatively couple the computing systems 100A-N of the distributed computing environment 111. Accordingly, the interconnect 115 may comprise a cluster interconnect for the computing systems 100A-N. The interconnect 115 may comprise any suitable electronic communication means including, but not limited to: may comprise one or more of a Small Computer Software Interconnect (SCSI), a Serial Attached SCSI (SAS), an iSCSI network, a Direct Memory Access (DMA) channel, a Remote DMA (RDMA) network, an Ethernet network, a fiber-optic network, a Transmission Control Protocol/Internet Protocol (TCP/IP) network, an Infiniband network, a Local Area Network (LAN), a Wide Area Network (WAN), a Virtual Private Network (VPN), a Storage Area Network (SAN), and/or the like.

The memory resources 106 of the computing system 100A may comprise system and/or cache memory. The memory resources 106 may comprise one or more Random Access Memory (RAM) modules and/or devices. The memory resources 106 may comprise volatile RAM, persistent RAM (e.g., battery-backed RAM), high-performance Flash, cache memory, and/or the like. The memory resources 106 may comprise memory resources that are tightly coupled to the processing resources 102, such as on-CPU cache. The memory resources 106 may further comprise memory management resources, such as a memory controller, a virtual memory manager, a cache manager, and/or the like. The storage resources 108 of the computing system 100A may comprise one or more non-transitory storage devices, which may be accessible through, inter alia, the I/O resources 104 of the computing system 100A (e.g., a SATA bus, PCIe bus, and/or the like). The storage resources 108 may comprise one or more magnetic hard drives, Flash storage devices, a Redundant Array of Inexpensive Disks (RAID), a network attached storage system (NAS), and/or the like. The storage resources 108 may further comprise higher-level storage services and/or layers, such as a storage driver, a file system, a database storage system, and/or the like. The storage resources 108 may be accessible through the I/O resources 104 of the computing system 100A.

The DCM 110 may be configured to operate on the computing system 100A (by use of the physical computing resources 101 thereof). In some embodiments, the DCM 110 is configured to operate within a local operating system of the computing system 100A (not shown). The local operating system may be configured to manage the physical computing resources 101 of the computing system 100A. The DCM 110 may comprise an application, user-level process, kernel-level process, driver, service, and/or the like operating within the operating system, and may access the physical computing resources 101 of the computing system 100A through, inter alia, the operating system. Alternatively, in some embodiments, the DCM 110 may be implemented as a component or module of the local operating system. In other embodiments, the DCM 110 comprises operating system functionality and directly manages the physical computing resources 101 of the computing system 100A.

Portions of the DCM 110, and the modules, elements, and/or components thereof, may be embodied as computer-readable instructions stored on non-transitory storage, such as the storage resources 108 of the computing system 100A. The computer-readable instructions may be executable by the computing system 100A to implement certain functionality of the DCM 110, as disclosed herein. Alternatively, or in addition, portions of the DCM 110, and the modules, elements, and/or components thereof, may be embodied as hardware, which may include, but is not limited to: an integrated circuit, a programmable circuit, a Field Programmable Gate Array (FPGA), a general purpose processor, a special-purpose processor, a co-processor, a peripheral device, and/or the like. In some embodiments, portions of the DCM 110 disclosed herein, and the modules, elements, and/or components thereof, may be embodied as firmware, which may include, but is not limited to, instructions and/or configuration data stored on a non-volatile Read-Only Memory (ROM), an Electrically Erasable Programmable Read-Only Memory (EEPROM), a Flash EPROM, and/or the like. The firmware of the DCM 110 may comprise computer-readable instructions, configuration data, hardware configuration data (e.g., FPGA configuration data), and/or the like.

The distributed computing manager (DCM) 110 may be communicatively coupled to other computing systems of the distributed computing environment 111. In the FIG. 1 embodiment, the DCM 110 is communicatively coupled to computing systems 100B-N through the interconnect 115. Each of the computing systems 100B-N may comprise physical computing resources (not shown). The computing systems 100B-N may further comprise a respective DCM 110 and/or portions of a DCM 110 (e.g., one or more components, elements, and/or modules of a DCM 110). As disclosed in further detail herein, the DCM 110 may be configured to manage computing resources available in the distributed computing environment 111 as computing resources of a single computing system (e.g., a computing system having a single CPU, or single core, a unitary I/O space, a unitary memory space, a unitary storage space, and so on).

In the FIG. 1 embodiment, the DCM 110 is configured to present the combined computing resources of the computing systems 100A-N of the distributed computing environment 111 as a single, unitary computing system within a host environment 112. As used herein, the computing resources of the distributed computing environment 111 may include, but are not limited to: the physical computing resources 101 of the computing system 100A, computing resources accessible to the DCM 110, physical computing resources of computing systems 100B-N, computing resources accessible to the respective computing systems 100B-N, and so on.

The DCM 110 may present the combined computing resources as a set of emulated computing resources (ECR) 121 within the host environment 112. As disclosed above, the ECR 121 may comprise a simplified, homogeneous computing environment that emulates the combined computing resources of the distributed computing environment 111 as a single computing system (e.g., a single processor or processing core, memory, I/O and storage system). The ECR 121 may, therefore, include, but are not limited to: an emulated processor 122, emulated I/O 124, emulated memory 126, emulated storage (not shown), and so on.

The emulated processor 122 may correspond to a particular processor, processor architecture, processing unit, processing core, and/or the like. The DCM 110 may manage the emulated processor 122 such that instructions submitted thereto are distributed for execution within the distributed computing environment 111. The emulated I/O 124 may emulate a shared I/O system that spans the computing systems 100A-N of the DCM 110. The emulated I/O 124 may manage an emulated I/O address space that includes I/O devices of the computing system 100A and one or more remote computing systems 100B-N. Accordingly, I/O devices of other computing systems 100B-N may be accessible through the emulated I/O 124 as if the devices were local to the computing system 100A. The emulated memory 126 may comprise a memory address space that spans the computing systems 100A-N. The emulated memory 126 may combine the memory address space of the memory resources 106 of the computing system 100A with memory address space(s) of one or more of the computing systems 100B-N. Memory addresses of the emulated memory 126 may, therefore, map to physical memory of any one of the computing systems 100A-N. In some embodiments, the ECR 121 may further comprise emulated storage (not shown). As disclosed in further detail herein, the emulated storage may comprise a storage address space that spans a plurality of storage resources of respective computing systems 100A-N (e.g., the storage resources 108 of the computing system 100A). The emulated storage may comprise a storage address space (e.g., a logical block address space) that maps to storage resources of any one of the computing systems 100A-N. Alternatively, the storage resources 108 of the computing systems 100A-N may be presented through the emulated I/O 124, as disclosed above.

The host environment 112 may be configured to host a guest 130. As used herein, a “guest” refers to one or more of an operating system (e.g., a guest operating system), computer-readable instructions, an application, a process, and/or the like. The guest 130 may operate within the host environment 112. Accordingly, in some embodiments, the host environment 112 comprises a virtual machine host, a virtual machine monitor, a hypervisor, an emulation environment, an emulation container, and/or the like. The guest 130 may perform computing operations by use of the ECR 121 presented within the host environment 112. The DCM 110 may distribute requests issued to the ECR 121 between the computing systems 100A-N of the distributed computing environment 111. More specifically, the DCM 110 may distribute instructions submitted to the emulated processor 122 for execution by processing resources of the respective computing systems 100A-N (e.g., the processing resources 102), may distribute I/O requests issued to the emulated I/O 124 to I/O resources of the respective computing systems 100A-N (e.g., the I/O resources 104 and/or storage resources 108), may distribute memory access requests to the emulated memory 126 across the computing systems 100A-N, and so on.

As disclosed above, the ECR 121 may correspond to the computing resources of a single computing system. Accordingly, the guest 130 may operate within the host environment 112 as if the guest 130 were operating within a single computing system (e.g., the computing system 100A). The guest 130 may, therefore, leverage the distributed processing functionality of the DCM 110 without being customized to operate within the distributed computing environment 111.

Computing operations of the guest 130 may be received through, inter alia, the ECR 121 of the host environment 112; instructions of the guest 130 may be executed through the emulated processor 122, I/O requests of the guest 130 may be serviced through the emulated I/O 124, memory access requests may be issued to the emulated memory 126, and so on. The DCM 110 may implement the computing operations by distributing the computing operations to the computing systems 100A-N within the distributed computing environment 111. Therefore, program instructions of the guest 130 may be executed by use of processing resources 102 of one or more different computing systems 100A-N, I/O requests of the guest 130 may be serviced by use of I/O resources 104 of one or more different computing systems 100A-N, memory accesses may correspond to memory resources 106 of one or more different computing systems 100A-N, and so on.

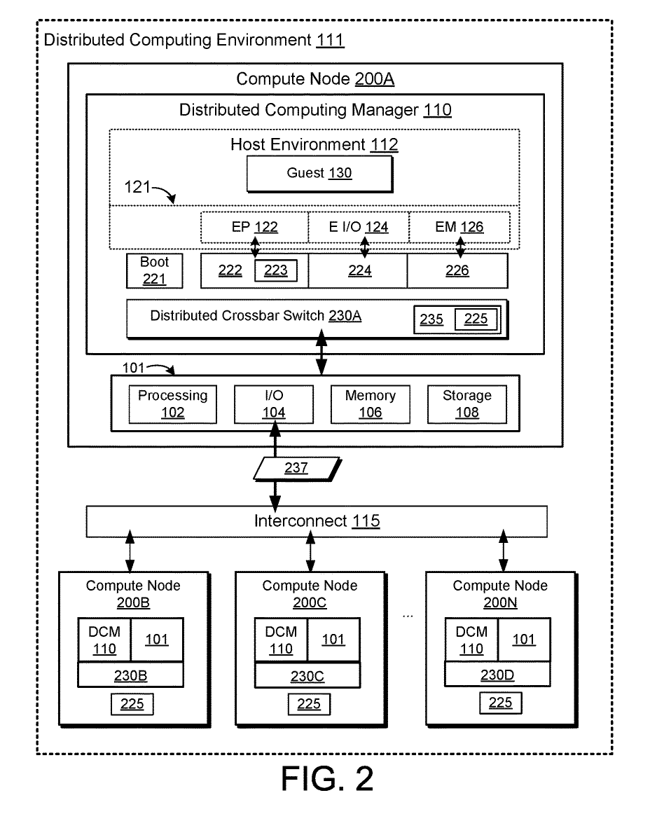

FIG. 2 is a schematic block diagram of another embodiment of a distributed computing environment 111. As disclosed above, the compute nodes 200A-N may be communicatively coupled to one another and may be configured to cooperatively operate to implement distributed computing operations. Accordingly, the distributed computing environment 111 may be referred to as comprising a cluster of compute nodes 200A-N. Each compute node 200A-N may comprise a respective computing device, such as a personal computer, server computer, blade, tablet, notebook, and/or the like. The compute nodes 200A-N may comprise respective physical computing resources 101, such as processing resources 102, I/O resources 104, memory resources 106, and/or storage resources 108, as disclosed herein.

The compute node 200A may comprise a distributed computing manager (DCM) 110 configured to provide a host environment 112 on the compute node 200A, as disclosed herein. The DCM 110 may be further configured to manage distributed emulated computing resources (ECR) 121 for a guest 130 operating within the host environment 112. The host environment 112 may comprise an operating system kernel, hypervisor, virtual machine manager, and/or the like. In some embodiments, the host environment 112 comprises a modified BSD kernel. The disclosure, however, is not limited in this regard and could be implemented using any suitable emulation and/or virtualization environment.

In the FIG. 2 embodiment, the DCM 110 further comprises a boot manager 221, a distributed execution manager 222, a distributed I/O manager 224, a distributed memory manager 226, and a distributed crossbar switch (DCS) 230A. The boot manager 221 may be configured to enable the guest 130 to boot within the host environment 112. The boot manager 221 may emulate a boot environment for the guest 130. The boot manager 221 may be configured to emulate a basic input output system (BIOS), a Unified Extensible Firmware Interface (UEFI), and/or the like.

As disclosed herein, the DCM 110 may be configured to emulate a computing platform comprising a unitary processor, I/O, and memory. The DCM 110 may be configured to emulate any selected computing architecture and/or platform. The DCM 110 may be further configured to emulate execution of instructions on the selected computing architecture and/or platform using, inter alia, the distributed execution manager 222 and/or emulated execution units 223 (disclosed in further detail herein). The DCM 110 may be independent of proprietary hardware, such as proprietary network infrastructure, proprietary shared memory infrastructure, hardware virtualization support, and/or the like. Accordingly, the DCM 110 disclosed herein may be configured to implement the host environment 112 in a hardware agnostic manner capable of leveraging any suitable physical computing resources 101.

The distributed execution manager 222 may be configured to execute instructions submitted to the emulated processor 122. The distributed execution manager 222 may emulate the functionality of one or more physical execution units, processing units and/or cores. The distributed execution manager 222 may emulate any suitable processing architecture and, as such, may execute instructions of any suitable instruction set. In some embodiments, the distributed execution manager 222 emulates a single CPU (e.g., a CPU of the processing resources 102). The distributed execution manager 222 may be further configured to distribute instructions for execution on other compute nodes 200B-N by use of, inter alia, the DCS 230A, as disclosed in further detail herein.

The distributed I/O manager 224 may be configured to service I/O operations issued to the emulated I/O 124. The distributed I/O manager 224 may emulate the I/O resources 104 of the compute node 200A and/or I/O resources of one or more other compute nodes 200B-N. The distributed I/O manager 224 may be configured to emulate one or more of a system bus, system bus controller, PCI bus, PCI controller, PCIe bus, PCIe controller, network interface, and/or the like. The distributed I/O manager 224 may, therefore, be configured to provide I/O interfaces to the guest 130, such as a network interface, storage interface, USB interface(s), audio interface, keyboard, mouse, and so on. The distributed I/O manager 224 may be configured to provide I/O services by, inter alia, interfacing with the physical computing resources 101 of the compute node 200A, such as the I/O resources 104, as disclosed above. The distributed I/O manager 224 may be further configured to distribute I/O requests to be serviced at other compute nodes 200B-N by use of, inter alia, the DCS 230A, as disclosed in further detail herein.

The distributed memory manager 226 may manage memory access requests issued to the emulated memory 126. The distributed memory manager 226 may be configured to emulate a memory controller, a virtual memory management system, a cache manager, and/or the like. The distributed memory manager 226 may be configured to interface with the memory resources 106 of the compute node 200A to implement memory access requests. The distributed memory manager 226 may be further configured to distribute memory access requests to be serviced at other compute nodes 200B-N by use of, inter alia, the DCS 230A, as disclosed in further detail herein.

The DCS 230A may be configured to coordinate distributed computing operations between the compute nodes 200A-N. The DCS 230A may, therefore, comprise a middleware layer of the distributed computing environment 111 that coordinates operation and/or configuration of the compute nodes 200A-N. The DCS 230A may be configured to interface with the physical computing resources 101 of the compute node 200A in order to, inter alia, route instructions and/or data between the compute nodes 200A-N, and so on. As disclosed in further detail herein, the DCS 230A may be configured to distribute instructions issued through the emulated processor 122, emulated I/O 124, and/or emulated memory 126 to the DCM 110 of respective compute nodes 200A-N, manage execution of particular instructions by the distributed execution manager 222, distributed I/O manager 224, and/or distributed memory manager 226 at the compute node 200A, and/or manage execution of instructions from other compute nodes 200B-N by the distributed execution manager 222, distributed I/O manager 224, and/or distributed memory manager 226 at the compute node 200A. In some embodiments, the DCS 230A is configured to maintain distributed synchronization metadata 235, which may comprise metadata pertaining to one or more of the distributed execution manager 222, distributed I/O manager 224, distributed memory manager 226, and so on. The DCS 230A-N may synchronize the distributed synchronization metadata 235 between the compute nodes 200A-N of the distributed computing environment 111. In some embodiments, the DCS 230A transmits metadata synchronization messages 237 pertaining to the distributed synchronization metadata 235 to other compute nodes 200B-N (via the interconnect 115) in response to one or more of: updating the distributed synchronization metadata 235, locking a portion of the distributed synchronization metadata 235, unlocking a portion of the distributed synchronization metadata 235, adding a compute node 200B-N to the distributed computing environment 111, removing a compute node 200B-N from the distributed computing environment 111, and/or the like. The DCS 230A may be further configured to receive the metadata synchronization messages 237 from a remote compute node 200B-N, which may, inter alia, indicate an update to the distributed synchronization metadata 235 implemented at the remote compute node 200B-N, a lock on a portion of the distributed synchronization metadata 235 by the remote compute node 200B-N, release of a lock by the remote compute node 200B-N, and/or the like.

As disclosed above, the distributed execution manager 222 may be configured to emulate a single processor and/or processor core that spans the compute nodes 200A-N. The emulated processor 122 may be defined by, inter alia, distributed processor emulation metadata 225. The distributed processor emulation metadata 225 may be configured to, inter alia, define the architecture, configuration, and/or operating state of the emulated processor 122. The distributed processor emulation metadata 225 may, therefore, define the elements of the emulated processor 122 and the current operating state thereof. The elements of the emulated processor 122 may include, but are not limited to: data elements, such as registers, queues, buffers, CPU cache, and/or the like; structural elements, such as processing cores, processing units, logic elements, ALUs, FPUs, and/or the like; and control elements, such as branch predictors, cache controllers, queue controller, buffer controller, and/or the like. The distributed processor emulation metadata 225 may define the respective elements of the emulated processor, an arrangement and/or interconnections of the elements, operating state of the element(s), and so on. As used herein, the operating state of the emulated processor 122 and/or an element thereof, may comprise current state information pertaining to the element. The operating state of the emulated processor 122 may, therefore, include, but is not limited to: the operating state of data elements of the emulated processor 122, such as the contents of one or more registers, contents of a CPU buffer, contents of a CPU cache, contents of an instruction queue, and/or the like; the operating state of structural elements of the emulated processor 122, such as the contents of a pipelined FPU, the contents of an ALU, the contents of logical elements, and/or the like; the operating state of control elements of the emulated processor 122, such as the contents and/or configuration of a branch predictor, the contents and/or configuration of a CPU cache controller, the contents and/or configuration of an reorder buffer and/or alias table, and/or the like.

The distributed processor emulation metadata 225 may be synchronized between the compute nodes 200A-N by the respective DCS 230A-N (as part of the distributed synchronization metadata 235, disclosed above). The distributed processor emulation metadata 225 may define a current operating state of the processor being emulated within the distributed computing environment 111. Accordingly, each distributed execution manager 222 of each compute node 200A-N may be configured to emulate the same processor (e.g., may emulate the distributed processor using the same set of the distributed processor emulation metadata 225). Accordingly, to the guest 130, the distributed computing environment 111 may appear to provide a single processor and/or processor core.

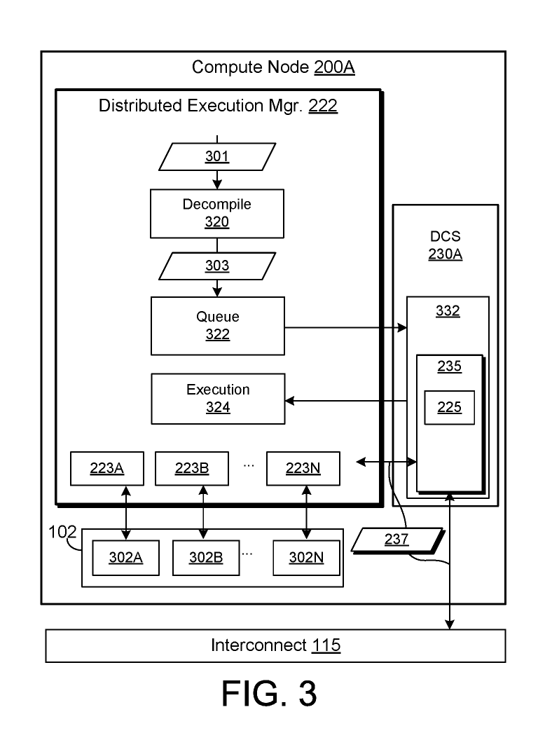

FIG. 3 is a schematic block diagram of one embodiment of a distributed execution manager 222 of the distributed computing environment 111, as disclosed herein. The distributed execution manager 222 may be configured to execute instructions 301 of the guest 130. The instructions 301 may comprise binary encoded instructions compiled for a particular processor architecture. The distributed execution manager 222 may be configured to emulate execution of the instructions 301 on a particular processor or processor core. The particular processor and/or processor core, and the current operating state thereof, may be defined in the distributed processor emulation metadata 225. As disclosed herein, the distributed processor emulation metadata 225 may be synchronized between the respective compute nodes 200A-N by the respective DCS 230A-N. The distributed execution managers 222 of the respective compute nodes 200A-N may, therefore, emulate the same processor (e.g., emulate the same instance of the same processor, as defined in the distributed processor emulation metadata 225).

The distributed processor emulation metadata 225 may correspond to any suitable processor architecture, including, but not limited to: X86, x86_64, SPARC, ARM, MIPS, Java Virtual Machine (JVM), and/or the like. The distributed processor emulation metadata 225 may define a state of various components and/or functional units of the emulated processor 122, which may include, but are not limited to: instruction fetch, instruction pre-decode, instruction queue, instruction decode, execution, execution sequencing, execution scheduling, pipelining, branch prediction, execution core(s), sub-processing core(s) (e.g., an arithmetic logic unit (ALU), a floating-point unit FPU, and/or the like), combinational logic, and so on. The distributed processor emulation metadata 225 may further define operating state of cache control and/or access for the emulated processor 122.

In the FIG. 3 embodiment, the DCS 230A is configured to, inter alia, maintain the distributed synchronization metadata 235 comprising the distributed processor emulation metadata 225. The DCS 230A may be configured to synchronize the distributed synchronization metadata 235, including the distributed processor emulation metadata 225 to other compute nodes 200A-N. Synchronizing the distributed processor emulation metadata 225 may comprise transmitting and/or receiving the metadata synchronization messages 237 pertaining to the distributed processor emulation metadata 225. Accordingly, each compute node 200A-N, and corresponding distributed execution manager 222, may operate on the same emulated processor 122 (e.g., emulate the same processor architecture using the same distributed processor emulation metadata 225).

The distributed execution manager 222 may be configured to emulate execution of the instructions 301 by use of the distributed processor emulation metadata 225 and/or one or more emulated execution units (EEU) 223. Emulating execution of an instruction 301 may comprise emulating one or more of instruction fetch, instruction pre-decode, instruction queue, instruction decode, execution, execution sequencing, execution scheduling, pipelining, branch prediction, execution core(s), sub-processing core(s) (e.g., an arithmetic logic unit (ALU), a floating-point unit FPU, and/or the like), combinational logic, cache control, cache access, and so on. The state of the various components and/or functional units, such as the contents of registers, instruction queue, and so on, may be maintained in the distributed processor emulation metadata 225, which may be synchronized between the compute nodes 200A-N, as disclosed above.

The distributed execution manager 222 and EEU 223A-N of FIG. 3 may be configured to emulate a particular processor architecture, such as x86_64. Accordingly, the emulated processor 122 of the FIG. 3 embodiment may comprise an x86_64 processor. The disclosure is not limited in this regard; however, any could be adapted to emulate any suitable processing architecture. In the FIG. 3 embodiment, the distributed execution manager 222 comprises a decompile unit 320, an instruction queue 322, and an execution manager 324. The decompile unit 320 may be configured to receive and/or fetch the binary instructions 301 for execution (e.g., fetch from memory by use of emulated cache control and/or the distributed memory manager 226, as disclosed in further detail herein). The decompile unit 320 may be further configured to decompile the binary instructions 301 into an intermediate format to produce instructions 303. The intermediate format may comprise an opcode format of the binary instructions 301 (e.g., an assembly language format). The decompile unit 320 may queue the instructions 303 in the queue 322. The queued instructions 303 may be distributed for execution by the DCS 230A, which may comprise executing the instructions 303 at the compute node 200A and/or distributing the instructions 303 for execution on one or more remote compute nodes 200B-N. The DCS 230A may be further configured to maintain and/or synchronize the distributed processor emulation metadata 225 within the distributed computing environment 111, as disclosed herein.

The instructions 303 assigned for execution at the compute node 200A-N may be executed by a respective one of the EEU 223A-N. Execution of the instructions 303 at the compute node 200A may be managed by, inter alia, the execution manager 324. The execution manager 324 may assign the instructions 303 to the respective EEU 223A-N (and/or may route the instructions 303 to the EEU 223A-N as assigned by an distributed execution scheduler 332). The EEU 223A-N may emulate execution of the instructions 303 by use of the processing resources 102 of the compute node 200A. Executing an instruction 303 may comprise accessing the distributed processor emulation metadata 225, emulating execution of the instruction 303 in accordance with the distributed processor emulation metadata 225, updating the distributed processor emulation metadata 225 in response to the execution, writing a result of the instruction 303 to memory (if any), and so on. Updating the distributed processor emulation metadata 225 by an EEU 223A may comprise, inter alia, transmitting a synchronization message 237 comprising the update to the distributed execution manager 222 and/or DCS 230A. In response, the distributed execution manager 222 and/or DCS 230A may update the distributed processor emulation metadata 225 and/or distribute the update to the other EEU 223B-N (by use of metadata synchronization message 237). The DCS 230A may be further configured to synchronize the updated distributed processor emulation metadata 225 to the other compute nodes 200B-N by use of one or more the metadata synchronization messages 237, as disclosed herein.

In some embodiments, each EEU 223A-N is assigned a respective processor core 302A-N of the processing resources 102. The EEU 223A-N may emulate execution of the instructions 303 assigned thereto by use of the respective processor cores 302A-N. As disclosed above, executing an instruction 303 at an EEU 223A-N may comprise emulating execution of the instruction 303 in accordance with the distributed processor emulation metadata 225. Emulating execution of the instruction 303 may comprise updating the distributed processor emulation metadata 225, which may include, but is not limited to: contents and/or state of one or more processor registers, contents and/or state of an execution pipeline, contents and/or state of a sub-core (e.g., an ALU, FPU, and/or the like), instruction pointers, an instruction queue, a branch predictor, and/or the like. The EEU 223A-N may transmit metadata synchronization messages 237 to the distributed execution manager 222 and/or DCS 230A comprising updates to the distributed processor emulation metadata 225 (if any).

In the FIG. 3 embodiment, the DCS 230A comprises the distributed execution scheduler 332 that assigns the queued instructions 303 to the particular compute nodes 200A-N by use of, inter alia, an execution assignment criterion. The distributed execution scheduler 332 may assign the instructions 303 using any suitable criterion including, but not limited to: physical proximity of the resources being accessed by the instruction 303 (e.g., whether a memory address of the instruction is available at the compute node 200A or must be fetched from a remote compute node 200B-N), assignments of other, related instructions 303, load on the compute nodes 200A-N (e.g., processor load, memory load, I/O load, and so on), health of the respective compute nodes 200A-N, and/or the like.

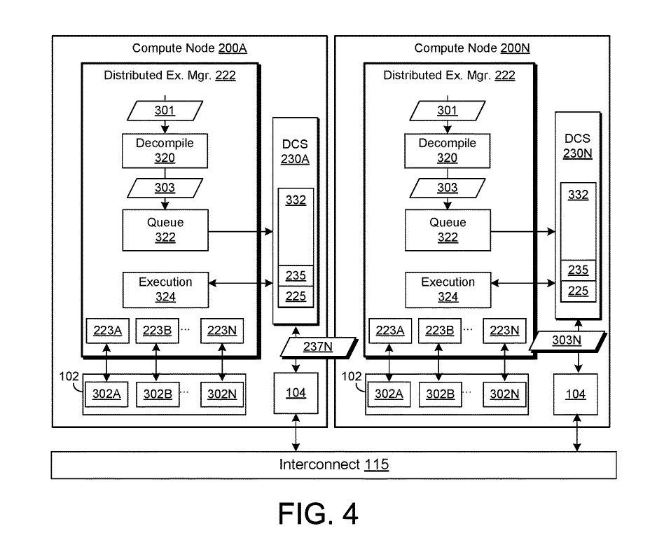

Referring to FIG. 4, the distributed execution scheduler 332 may assign an instruction 303N to the compute node 200N (based on an execution assignment criterion, as disclosed above). In response, the DCS 230A may transmit the instruction 303N, and/or corresponding metadata, to the compute node 200N via the interconnect 115 (and by use of the I/O resources 104 of the compute node 200A and/or 200N). The DCS 230N at the compute node 200N receives the instruction 303N and issues the instruction 303N to the distributed execution manager 222 operating thereon. The distributed execution manager 222 of the compute node 200N assigns and/or routes the instruction 303N to an EEU 223A-N, which emulates execution of the instruction 303N on a particular processor core 302A-N of the compute node 200N. As disclosed herein, emulating execution of the instruction 303N at the compute node 200N may comprise accessing an I/O device by use of the distributed I/O manager 224, accessing memory by use of the distributed memory manager 226, and/or the like. Emulating execution of the instruction 303N may further comprise updating the distributed processor emulation metadata 225 at the compute node 200N, transmitting a DPE synchronization message 337 to the distributed execution manager 222 and/or DCS 230N, and synchronizing the updated distributed processor emulation metadata 225 from the compute node 200N. Synchronizing the updated distributed processor emulation metadata 225 may comprise transmitting one or more metadata synchronization messages 237N from the DCS 230N to the DCS 230A of compute node 200A.

In some embodiments, emulating instruction execution may further comprise locking portion(s) of the distributed processor emulation metadata 225. The DCS 230A-N, distributed execution manager 222 and/or EEU 223A-N may identify portions of the distributed processor emulation metadata 225 that require exclusive access during emulated execution of particular instruction(s) 301 and/or 303. The identified portions may include, for example, portions of the distributed processor emulation metadata 225 to be accessed, modified, and/or otherwise manipulated during emulated execution of the particular instructions 301 and/or 303. Locking the identified portions of the distributed processor emulation metadata 225 may comprise requesting an lock from a designated compute node 200A-N, such as a master compute node 200A-N via a metadata synchronization message 237. The master compute node 200A-N may be configured to manage exclusive access to portions of the distributed processor emulation metadata 225 by the compute nodes 200A-N by, inter alia, granting lock(s), releasing lock(s), monitoring locks and/or scheduling execution to prevent deadlock conditions, and/or the like. The master compute node 200A-N may be further configured to synchronize updates to the distributed processor emulation metadata 225 such that the updates do not affect locked portions of the distributed processor emulation metadata 225 and/or may schedule updates to maintain coherency of the distributed processor emulation metadata 225 for concurrent access by multiple compute nodes 200A-N.

In some embodiments, the instructions 303 may be executed redundantly by a plurality of different compute nodes 200A-N. In one embodiment, each instruction 303 may be executed at two different compute nodes 200A-N, and the results of such execution may be maintained in separate storage and/or memory location(s) and/or in different sets of the distributed processor emulation metadata 225. The results of the separate execution may be used to, inter alia, validate the results, identify processing faults, ensure that processes are crash safe, and/or the like. In one embodiment, redundant results (and corresponding memory and/or the distributed processor emulation metadata 225) may be used to recover from the failure of one or more of the compute nodes 200A-N. The DCS 230A may be configured to execute the instructions 303 on any number of compute nodes 200A-N to achieve any suitable level of redundancy.

Referring back to FIG. 3, the decompile unit 320 may be configured to decompile the binary instructions 301 into an intermediate format (e.g., the instructions 303). The instructions 303 may comprise instruction opcodes. The instructions 303 may, therefore, be referred to as “opcode instructions” or “pseudo code.” The instructions 303 may be emulated on the respective EEU 223A-N using any suitable mechanism including, but not limited to: direct translation, emulation, simulation (e.g., a Micro Architectural and System Simulator, such as MARSSx86), implemented as a very long instruction word system, and/or the like. As disclosed above, emulating execution of an instruction 303 may comprise maintaining and/or updating the distributed processor emulation metadata 225, which may indicate a current operating state of the processor being emulated by the distributed computing environment 111.

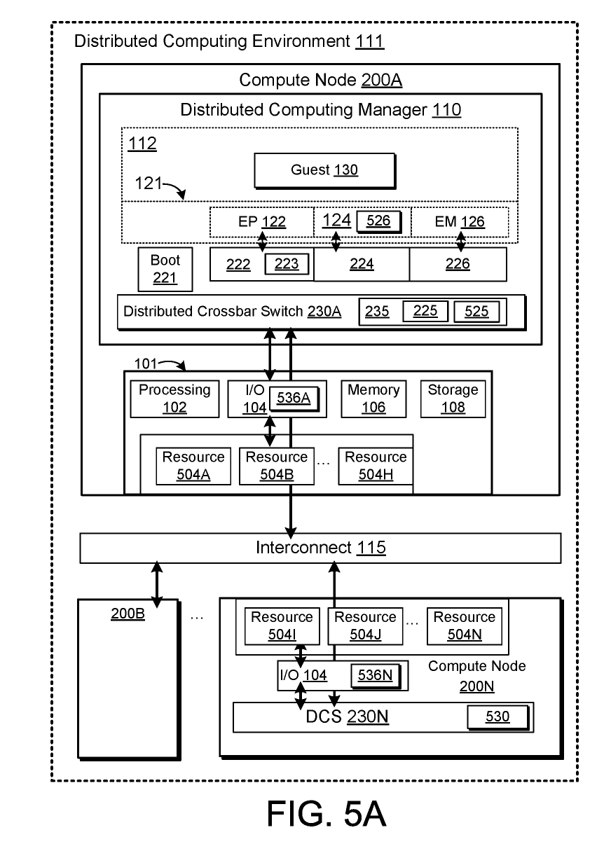

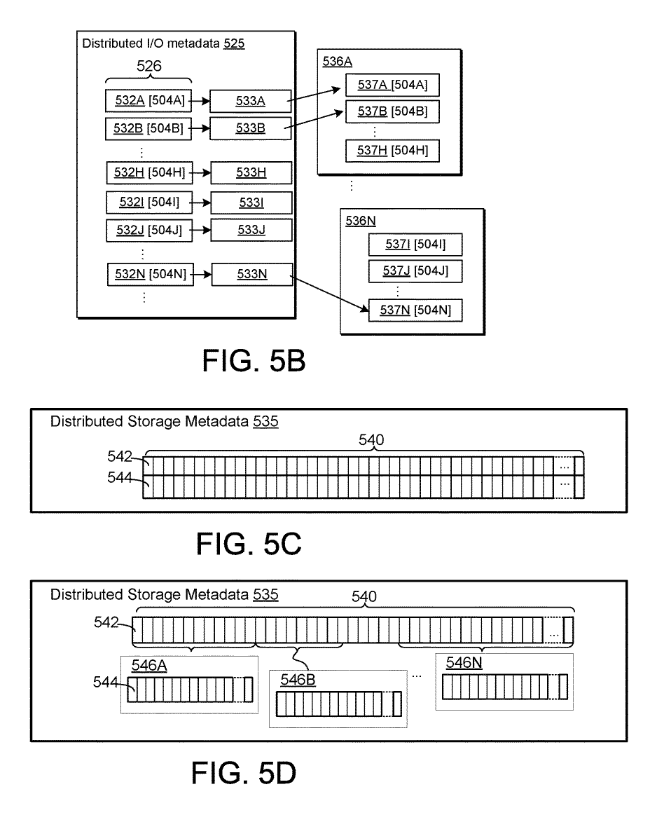

As disclosed above, the distributed I/O manager 224 may be configured to manage I/O operations within the distributed computing environment 111. The distributed I/O manager 224 may provide access to the I/O resources 104 of the compute nodes 200A-N, such as storage devices, USB devices, SATA controllers, SAS devices, PCIe devices, PCIe controllers, network interfaces, and so on. FIG. 5A is a block diagram of another embodiment of a distributed computing environment 111. In the FIG. 5A embodiment, the emulated I/O manager 224 is configured to manage distributed I/O resources that span the compute nodes 200A-N, including particular I/O resources 504A-H of the compute node 200A and particular I/O resources 504I-N of the compute node 200B. The I/O resources 104 of the compute node 200A may comprise local I/O metadata 536A. The local I/O metadata 536A may define an I/O namespace for the particular I/O resources 104 of a compute node 200A-N (e.g., defines an I/O namespace for local I/O resources 504A-H of compute node 200A). As disclosed herein, I/O resources 104 of the compute nodes 200A-N, and the particular I/O resources 504A-N thereof, may include, but are not limited to: I/O devices, PCIe devices, I/O interfaces, PCIe bus interfaces, I/O buses and/or interconnects, PCIe buses, I/O controllers, PCIe controllers, storage devices, PCIe storage devices, network interfaces, network cards, network-accessible I/O resources, network-accessible storage, and/or the like.

As disclosed herein, the DCM 110 may present and/or provide access to the I/O resources 104 of the compute nodes 200A-N through emulated I/O resources 124. The emulated I/O resources 124 may comprise a distributed I/O namespace 526 through which particular I/O resources 504A-N of the respective compute nodes 200A-N may be referenced. The DCM 110 may manage the distributed I/O namespace 526, such that the I/O resources 504A-N of the compute nodes 200A-N appear to be hosted on a single computing system or device (e.g., on a particular compute node 200A-N). In some embodiments, the distributed I/O namespace 526 comprises a single, contiguous namespace that includes particular I/O devices of the compute nodes 200A-N. The DCM 110 may be configured to register the particular I/O devices 504A-N within the distributed I/O namespace 526 using, inter alia, emulated I/O identifiers, emulated I/O addresses, and/or the like. The distributed I/O namespace 526 may, in one embodiment, comprise an emulated translation lookaside buffer (TLB) comprising the I/O resources 504A-N of the compute nodes 200A-N. The DCM 110 may manage the emulated I/O 124, such that the guest 130 and/or instructions thereof, may reference the particular I/O resources 504A-N of the distributed I/O namespace 526 through standard I/O interfaces; the emulated I/O identifiers, emulated I/O addresses, emulated I/O references, emulated TLB, and/or the like of the distributed I/O namespace 526 may be referred to and/or comprise standard I/O identifiers, I/O addresses, I/O references, TLB, and/or the like. Therefore, the combined I/O resources 504A-N of the compute nodes 200A-N may be presented and/or accessed through the emulated I/O 124 (and distributed I/O namespace 526) of the compute node 200A as physical I/O resources 104 of the compute node 200A.

As illustrated in FIG. 5A, the compute nodes 200A-N may comprise respective local I/O metadata 536A-N (the specific details of some compute nodes, such as compute node 200B are not shown in FIG. 5A to avoid obscuring the details of the particular embodiments illustrated therein). The local I/O metadata 536A-N may comprise an I/O namespace for the I/O resources 104 of the respective compute nodes 200A-N. The local I/O metadata 536A-N may be managed by an operating system of the respective compute nodes 200A-N. Alternatively, or in addition, the DCM 110 may extend and/or replace the I/O management functions of the operating system (and/or may comprise an operating system or kernel). The local I/O metadata 536A of the compute node 200A may comprise a local I/O namespace through which the particular I/O resources 504A-H may be referenced and/or accessed at the compute node 200A, the local I/O metadata 536N of the compute node 200N may comprise a local I/O namespace through which the particular I/O resources 504I-N may be referenced and/or accessed at the compute node 200N, and so on. The local I/O metadata 536A-N may comprise any suitable I/O namespace and/or access interface including, but not limited to: I/O identifiers, I/O addresses, I/O references, a TLB, and/or the like. As disclosed in further detail herein, the local I/O metadata 536A-N may further comprise translation metadata to, inter alia, translate I/O requests directed to the distributed I/O namespace 526 to I/O requests to the particular I/O resources 504A-N of the respective compute nodes 200A-N. In one embodiment, the local I/O metadata 536A-N comprises maps emulated I/O identifiers, addresses, and/or the like of the distributed I/O namespace 526 to local I/O identifiers, addresses, and/or the like of the physical I/O resources 104 of the compute node 200A-N. As illustrated in FIG. 5A, the I/O resources 104 at the compute node 200A may comprise local I/O metadata 536A pertaining to the particular I/O resources 504A-J of the compute node 200A, the compute node 200N may comprise local I/O metadata 536N pertaining to the particular I/O resources H-N of the compute node 200N, and so on.

The distributed I/O manager 224 of the DCM 110 may be configured to service I/O requests received through the emulated I/O 124 (e.g., emulated I/O requests). The distributed I/O manager 224 may access the distributed I/O metadata 525 to translate the emulated I/O requests into local I/O requests of a particular compute node 200A-N (by use of distributed I/O metadata 525, as disclosed in further detail herein). The distributed I/O manager 224 may be further configured to translate an emulated I/O request into a local I/O request that references a local I/O namespace, of a determined compute node 200A-N, and may service the I/O requests at the determined compute node 200A-N. In the FIG. 5A embodiment, the distributed I/O manager 224 of compute node 200A may service emulated I/O requests pertaining to I/O resources 504A-J of the compute node 200A by use of the I/O resources 104 (and local I/O metadata 536A) of the compute node 200A. The distributed I/O manager 224 may be further configured to service emulated I/O requests pertaining to I/O resources 504H-N of other compute nodes 200B-N by, inter alia, issuing the I/O request to the respective compute nodes 200B-N.

As disclosed above, the DCM 110 may manage distributed I/O metadata 525 that, inter alia, defines a distributed I/O namespace 526 that includes the particular I/O resources 504A-N of the compute nodes 200A-N. The distributed I/O metadata 525 may provide for referencing the I/O resources 504A-N spanning the compute nodes 200A-N within the distributed I/O namespace 526 (e.g., using emulated I/O identifiers, addresses, references, names, and/or the like). The distributed I/O metadata 525 may comprise translations between the emulated I/O 124 presented within the host environment 112 and the local I/O resources 504A-N of the respective compute nodes 200A-N. Accordingly, in some embodiments, the distributed I/O metadata 525 is configured to map emulated I/O addresses, identifiers, references, names, and/or the like of emulated I/O resources of the distributed I/O namespace 526 to local I/O addresses, identifiers, references, names, and/or the like of the local I/O metadata 536A-N for the particular I/O resources 504A-N at the respective compute nodes 200A-N. In some embodiments, the distributed I/O metadata 525 comprises an emulated TLB comprising translation metadata for each of the particular I/O resources 504A-N included in the distributed I/O namespace 526. Accordingly, the eTLB of the distributed I/O metadata 525 may span the I/O namespaces (and respective local I/O metadata 536A-N) of the compute nodes 200A-N, and identifiers of the distributed I/O namespace 526 may correspond to respective local I/O identifiers of particular I/O devices 504A-N at the respective compute nodes 200A-N.

FIG. 5B depicts one embodiment of distributed I/O metadata 525 and local device metadata 536A-N. Metadata pertaining to other compute nodes (e.g., local metadata 536B of compute 200B) is omitted from FIG. 5B to avoid obscuring the details of the illustrated embodiments. The distributed I/O metadata 525 may comprise a distributed I/O namespace 526 that provides for referencing I/O resources 104 of a plurality of compute nodes 200A-N. In the FIG. 5B embodiment, the distributed I/O metadata 525 comprises a plurality of emulated I/O resource entries 532A-N, each of which may correspond to a respective one of the particular I/O resources 504A-N of a particular compute node 200A-N. The emulated I/O resource entries 532A-N may register the respective I/O resources 504A-N in the distributed I/O namespace 526. Accordingly, the emulated I/O resources entries 532A-N may assign an emulated I/O address, identifier, reference, name, and/or the like, to the respective I/O resources 504A-N. The emulated I/O resource entries 532A-N may be mapped to local I/O resource entries 533A-N, which may, inter alia, identify the compute node 200A-N through which the corresponding I/O resources 504A-N are accessible. The local I/O resource entries 533A-N may further comprise metadata to enable emulated I/O requests to be translated and/or issued to the respective compute nodes 200A-N of the particular I/O resources 504A-N. The local I/O metadata entries 533A-N may, for example, comprise a link and/or reference to an entry for the particular I/O resource 504A-N in local I/O metadata 536A and/or 536N of a respective compute node 200A-N. As illustrated in FIG. 5B, I/O resources 504A-J of compute node 200A are registered within the distributed I/O namespace 526 by use of, inter alia, emulated I/O resource entries 532A-J, and I/O resources 504H-N of compute node 200N are registered within the distributed I/O namespace 526 by use of, inter alia, emulated I/O resources entries 532H-N. The emulated I/O resource entries 532A-N correspond to respective local I/O resource entries 533A-N, which correspond to local I/O metadata 536A-N of the respective compute nodes 200A-N. Accordingly, references to emulated I/O resources of the distributed I/O namespace 526 may be translated to the particular I/O resources 504A-N of respective compute nodes 200A-N.

Referring back to FIG. 5A, the guest 130 may issue I/O requests to emulated I/O resources 124 by use of the distributed I/O namespace 526 (e.g., by use of emulated I/O addresses, identifiers, references, names, and/or the like assigned to the particular I/O resources 504A-N in the distributed I/O namespace 526). As disclosed above, the DCM 110 and distributed I/O manager 224 may present the emulated I/O resources 124 to the guest 130 using standardized I/O interfaces. Accordingly, the emulated I/O addresses, identifiers, references, names, and/or the like of the distributed I/O namespace 526 may be referred to and/or comprise standard I/O addresses, identifiers, references, names, and/or the like.

Similarly, emulated I/O requests received through the emulated I/O resources 124 may be referred to and/or comprise standard I/O requests.

The distributed I/O manager 224 may service emulated I/O requests by, inter alia, a) accessing the distributed I/O metadata 525 to identify a corresponding emulated I/O resource entry 532A-N, and b) servicing the I/O request at the compute node 200A-N that corresponds to the emulated I/O resource entry 532A-N. The distributed I/O manager 224 of compute node 200A may service I/O requests directed to I/O resources 504A-H of the compute node 200A by interfacing with the physical computing resources 101 of the compute node 200A (e.g., using the I/O resources 104 and local I/O metadata 536A of compute node 200A). More particularly, the distributed I/O manager may use the local I/O resource entry 533A-N corresponding to the identified I/O resource entry 532A-N to access local I/O metadata 532A-H for the particular I/O resource 504A-N in the local I/O metadata 536A of the compute node 200A. The distributed I/O manager 224 may coordinate with other compute nodes 200B-N to service I/O requests that correspond to other compute nodes 200B-N. More particularly, the distributed I/O manager 224 may service I/O requests directed to the remote devices 504I-N by determining the compute node 200B-N through which the I/O resource 504H-N is accessible (by use of the local I/O resource entry 533I-N corresponding to the identified emulated I/O resource entry 532A-N), and issuing the emulated I/O request to the determined compute node 200B-N (e.g., compute node 200N) by use of, inter alia, the DCS 230A and/or the interconnect 115. In response, the compute node 200N may access local I/O metadata 536N for the particular I/O resource 504H-N and service the I/O request by use of the I/O resources 104 of the compute node 200N. In one embodiment, the distributed I/O manager 224 issues the emulated I/O request directly to the compute node 200B, and in response, the DCS 230N and/or distributed I/O manager 224 (not shown) of the compute node 200B a) identifies the corresponding emulated I/O resource entry 532I-N in the distributed I/O metadata 525, b) accesses local I/O metadata 536N for the particular I/O resource 504I-N (by use of a corresponding local I/O metadata entry 533I-N), c) translates the emulated I/O request into a local I/O request by use of the local I/O metadata 536N, d) services the translated I/O request use of the local I/O resources 104 of the compute node 200N, and e) returns a response and/or result of the emulated I/O request to the distributed I/O manager 224 of compute node 200A through the interconnect 115.

The distributed I/O manager 224 may be further configured to manage distributed storage resources of the distributed computing environment 111. Referring to FIG. 5C, the distributed I/O manager 224 and/or DCS 230A may be configured to maintain distributed storage metadata 535. The distributed storage metadata 535 may be part of the distributed I/O metadata 525 and/or may be embodied as a separate data structure. The distributed storage resources may comprise a distributed storage address space 540, which may comprise a range, extent, and/or plurality of emulated storage addresses 542. The DCM 110 may manage and/or present the distributed storage address space 540 within the host environment 112 through the emulated I/O 124. Alternatively, the DCM 110 may manage and/or present the distributed storage address space 540 within the host environment 112 as separate emulated storage resources (not shown). As used herein, an “emulated storage address” of the distributed storage address space 540 may refer to any suitable identifier for referencing a storage resource. In some embodiments, the DCM 110 manages the emulated storage resource and/or distributed storage metadata 535, such that applications operating with the host environment 112 may access such resources through a standard storage interface, such as a block storage interface. Accordingly, the emulated storage addresses 542 of the distributed storage address space 540 may comprise block addresses, logical block addresses, logical block identifiers, virtual block addresses, virtual block identifiers, emulated block addresses, emulated block addresses, emulated block identifiers, and/or the like.

In one embodiment, the distributed storage metadata 535 associates emulated storage addresses 542 of the distributed storage address space 540 with respective local storage addresses 544. Each local storage address 544 may correspond to a storage address at a particular compute node 200A-N. The local storage addresses 544 may uniquely reference a “block” (or other quantum of storage capacity) within the storage resources 108 of a particular compute node 200A-N. Local storage addresses 544 may comprise physical storage addresses (e.g., disk addresses), logical block addresses, and/or the like. The local storage addresses 544 may identify the compute node 200A-N of the local storage address 544. In the FIG. 5C embodiment, the distributed storage metadata 535 associates each emulated storage address 542 with a respective local storage address 544. Given an emulated storage address 542, the DCS 230A and/or distributed 10 manager 224 may determine the local storage address 544 by identifying the local storage address 544 for the emulated storage address 542 in the distributed storage metadata 535, which may define the compute node 200A-N storage device, and local storage address 544 for the emulated storage address 542.

FIG. 5D depicts another embodiment of distributed storage metadata 535. In the FIG. 5D embodiment, the distributed storage metadata 535 associates ranges, extents, and/or sets of emulated storage addresses 542 with respective entries 546A-N that define a range, extent, and/or set of local storage addresses 544 at a particular compute node 200A-N. The entries 546A-N may identify the compute node 200A of the local storage addresses 544, and define a start, offset, and/or extent for the local storage addresses 544. Given a emulated storage address 542, the DCS 230A and/or distributed 10 manager 224 may determine the local storage address 544 by a) identifying the entry 546A-N for the emulated storage address 542, and b) determining the corresponding local storage address 544 by use of the entry 546A-N (e.g., by determining the compute node 200A-N and/or storage device of the local storage address 544, and determining an offset within the corresponding range, extent, and/or set of local storage addresses 544).

Referring to FIG. 2, the DCM 110 may further comprise the distributed memory manager 226 configured to, inter alia, manage a memory address space of the distributed computing environment 111. The memory address space may span respective memory resources 106 of the compute nodes 200A-N of the distributed computing environment 111. In some embodiments, the distributed memory manager 226 replaces and/or modifies a memory management system of the local operating system. Alternatively, or in addition, the distributed memory manager 226 may extend and/or augment an existing memory management system of a local operating system.

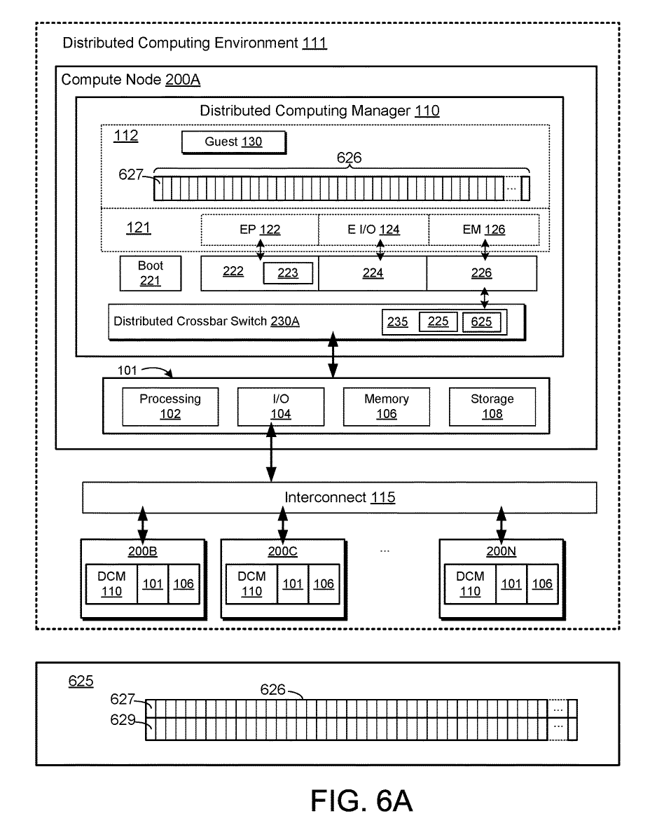

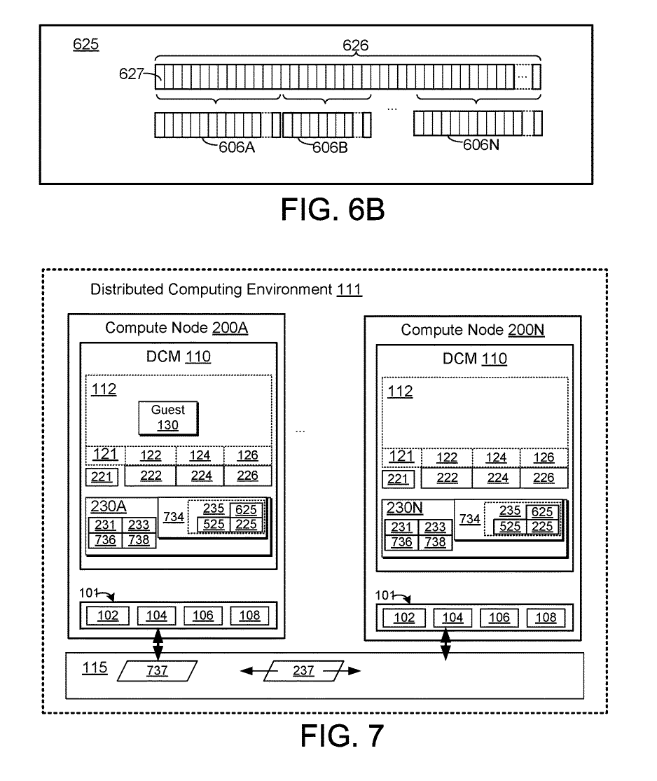

FIG. 6A is a block diagram of another embodiment of a distributed computing environment 111. In the FIG. 6A embodiment, the distributed memory manager 226 is configured to manage a distributed memory space 626 that spans the memory resources 106 of a plurality of compute nodes 200A-N. The DCM 110 may present the distributed memory space 626 within the host environment 112 and, as such, the distributed memory space 626 may be accessible to the guest 130, and executable instructions of the quest 130 may reference memory resources using addresses within distributed memory space 626. The distributed memory space 626 may comprise a range, extent, and/or set of identifiers. The guest 130, and the instructions thereof, may reference distributed memory space 626 using any suitable identifiers and/or addresses. In some embodiments, the DCM 110 is configured to present the emulated memory 126, and corresponding distributed memory space 626, through a standardized memory interface, such that the guest 130 and/or instructions thereof, may access such resources as if the emulated memory 126 and/or distributed memory address space 626 were local, physical memory resources 106 of the compute node 200A. Identifiers of the distributed memory space 626 may, therefore, be referred to as “memory address,” “emulated memory address,” “virtual memory address,” and/or the like.

As disclosed above, the distributed memory manager 226 services memory access requests issued to the emulated memory 126. Servicing a memory access request may comprise translating a memory address from the distributed memory space 626 to a memory address of a particular compute node 200A-N, and implementing the operation at the translated memory address. The distributed memory manager 226 may translate memory addresses by use of a distributed memory metadata 625. The distributed memory metadata 625 may comprise mappings between memory addresses of the distributed memory space 626 to physical memory addresses (e.g., a memory address of the memory resources 106 of a particular compute node 200A-N). FIG. 6A further illustrates one embodiment of the distributed memory metadata 625. The distributed memory metadata 625 of FIG. 6A comprises a plurality of distributed memory address entries 627. Each distributed memory address entry 627 may represent one or more memory addresses within the distributed memory space 626 (e.g., a range, extent and/or page of memory addresses). As disclosed above, such addresses may comprise one or more of a memory address, an emulated memory address, a virtual memory address, and/or the like. The DCM 110 may manage the emulated memory 126 and/or distributed memory address space 626 such that applications operating within the host environment 112 may access the emulated memory resources 126 through a standard memory interface, as if accessing physical memory resources 106 of the compute node 200A. The memory addresses of the distributed memory address space (e.g., entries 627) may have corresponding translation entries 629 that specify physical memory address(es) corresponding thereto. The physical memory address(es) of a distributed memory address entry 627 may specify a particular compute node 200A-N, and a local memory address within the memory resources 106 of the specified compute node 200A-N. Therefore, in response to a request pertaining to a memory address within the distributed memory space 626, the distributed memory manager 226 may determine the corresponding physical address by a) accessing the distributed memory address entry 627 for the memory address in the distributed memory metadata 625, and b) determining the physical memory address from the corresponding translation entry 629. Although a particular data structure for the distributed memory metadata 625 is disclosed herein, the disclosure is not limited in this regard, and could be adapted to use suitable mapping and/or translation between the distributed memory space 626 and physical memory resources 106 of the compute nodes 200A-N.

FIG. 6B illustrates another embodiment of a distributed memory metadata 625. In the FIG. 6B embodiment, contiguous regions of the distributed memory space 626 translate to respective regions 606A-N within the physical memory resources 106 of the compute nodes 200A-N. Each of the regions 606A-N may correspond to a range and/or extent of the memory resources 106 of a particular compute node 200A-N. The regions 606A-N may be defined at respective offsets and/or extents within the distributed memory space 626. The distributed memory manager 226 may translate a memory address of the distributed memory space 626 by a) determining the region 606A-N corresponding to the memory address, and b) determining an offset and/or relative memory address within the respective region 606A-N.

Referring back to FIG. 6A, the distributed memory manager 226 may implement a memory operation pertaining to a particular memory address within the distributed memory space 626 by, inter alia, determining the physical address of the particular memory address by use of the distributed memory metadata 625. If the physical address corresponds to the compute node 200A, the distributed memory manager 226 may implement the memory operation by use of the memory resources 106. If the physical address corresponds to a remote compute node 200B-N, the distributed memory manager 226 may issue the memory operation to the remote compute node 200B-N by use of the DCS 230A and/or the interconnect 115. Similarly, the distributed memory manager 226 may implement memory operations from remote compute nodes 200B-N in the memory resources 106 of the compute node 200A.

The DCS 230A may be configured to synchronize the distributed memory metadata 625 to the other compute nodes 200A-N. In response to a particular compute node 200A-N leaving the distributed computing environment 111, the DCS 230A may update the distributed memory metadata 625 to remove memory addresses that translate to physical memory addresses of the particular compute node 200A-N. In some embodiments, the DCS 230A may transfer the contents of such memory (if any) to other memory locations within the distributed memory space 626. The DCS 230A may be further configured to transmit the updated distributed memory metadata 625 to the remaining compute nodes 200A-N and/or otherwise inform the compute nodes 200A-N of the modifications to the distributed memory space 626. In some embodiments, the DCS 230A may be configured to inform the guest 130 of changes to the distributed memory space 626 so that the guest 130 may avoid attempting to access memory addresses that have been removed from the distributed computing environment 111.

The distributed memory manager 226 and/or DCS 230A may be further configured to provide memory redundancy. The addresses of the distributed memory space 626 may map to two or more physical memory addresses. The distributed memory manager 226 may be configured to write memory to an address of the distributed memory space 626 by a) translating the address to two or more physical memory addresses, by use of the distributed memory metadata 625, and b) writing the data to each of the two or more physical addresses. The distributed memory manager 226 may be configured to read a memory address of the distributed memory space 626 by a) translating the memory address to two or more physical addresses, b) reading the contents of each of the two or more physical addresses, and c) validating the memory contents by, inter alia, comparing the data read from each of the two or more physical addresses. Alternatively, the distributed memory manager 226 may access data from only a single physical address, and may access data at other physical address(es) only if a failure condition occurs.

As disclosed above, the DCS 230A of the compute node 200A may be configured to, inter alia, manage communication and data synchronization within the distributed computing environment 111. The DCS 230A may be configured to synchronize state metadata between the compute nodes 200A-N, which may include, but is not limited to: distributed processor emulation metadata 225, distributed I/O metadata 525, distributed memory metadata 625, and so on, as disclosed herein. The DCS 230A may be further configured to distribute instructions for execution at the compute nodes 200A-N, manage I/O devices that span the compute nodes 200A-N, manage distributed memory access requests (distributed memory space 626), and so on, as disclosed herein.

FIG. 7 is a block diagram of one embodiment of a distributed computing environment 111 comprising a plurality of compute nodes 200A-N, each having a respective DCM 110. The DCS 230A-N of the respective compute nodes 200A-N may comprise a metadata synchronization engine 734 configured to, inter alia, maintain and/or synchronize distributed synchronization metadata 235 within the distributed computing environment 111. The distributed synchronization metadata 235 may include, but is not limited to: distributed processor emulation metadata 225, distributed I/O metadata 525, distributed memory metadata 625, and so on. The distributed processor emulation metadata 225 may comprise, inter alia, metadata pertaining to the operating state of a particular processor and/or processor architecture being emulated within the distributed computing environment 111. The distributed processor emulation metadata 225 may be synchronized between the respective compute nodes 200A-N, such that the distributed execution manager(s) 222 of the respective compute nodes 200A-N access and/or update the same set of distributed processor emulation metadata 225. Accordingly, each of the compute nodes 200A-N may be configured to emulate the same instance of the same emulated processor 122. The distributed I/O metadata 525 may comprise metadata pertaining to I/O devices of the respective compute nodes 200A-N (e.g., emulated I/I metadata entries 532A-N and/or physical I/O metadata entries 533A-N corresponding to each I/O device available in the distributed computing environment 111), as disclosed herein. The distributed memory metadata 625 may comprise translation metadata for translating memory addresses of a distributed memory space 626 that spans memory resources 106 of the respective compute nodes 200A-N, to particular physical memory addresses on particular compute nodes 200A-N, as disclosed herein. The distributed synchronization metadata 235 may further comprise metadata pertaining to the distributed computing environment 111, which may include, but is not limited to: security metadata pertaining to the compute nodes 200A-N admitted into the distributed computing environment 111, communication metadata for the respective compute nodes 200A-N, load on the respective compute nodes 200A-N, health of the respective compute nodes 200A-N, performance metadata pertaining to the respective compute nodes 200A-N, and/or the like. The security metadata may comprise a security credential, shared key, and/or the like. The security metadata may, inter alia, enable mutual authentication between the compute nodes 200A-N. The security metadata may further comprise identifying information pertaining to the compute nodes 200A-N, such as unique identifier(s) assigned to the compute nodes 200A-N, network names and/or addresses assigned to the compute nodes 200A-N, and/or the like. The communication metadata may comprise network address and/or routing metadata pertaining to the compute nodes 200A-N. The communication metadata may be authenticated and/or validated by use of the security metadata disclosed above. The load metadata may indicate a current load on the physical computing resources 101 of the respective compute nodes 200A-N. The health metadata may indicate a health of the respective nodes 200A-N (e.g., temperature, error rate, and/or the like). The performance metadata may comprise performance metrics for the respective computing nodes 200A-N, which may include, but is not limited to: communication latency and/or bandwidth between the respective compute nodes 200A-N (e.g., latency for communication between compute nodes 200A and 200N), execution latency for instructions executed at the respective compute nodes 200A-N, access latency for memory, storage, and/or I/O operations at the respective compute nodes 200A-N, and so on.

The DCS 230A-N may comprise a distributed kernel module 231 configured to replace and/or modify portions of the operating system of the respective compute nodes 200A-N. The distributed kernel module 231 may be configured to replace and/or modify one or more components of the operating system, such as the network stack (TCP/IP stack), scheduler, shared memory system, CPU message passing system, Advanced Programmable Interrupt Controller (APIC), and/or the like. The distributed kernel module 231 may, therefore, be configured to manage high-performance network and/or memory transfer operations between the compute nodes 200A-N, without the need for proprietary hardware. In some embodiments, the distributed kernel module 231 comprises a messaging engine 233 to facilitate communication of data, configuration, and/or control between the compute nodes 200A-N. The messaging engine 233 may be configured for the high-performance transfer of: the instructions 303 (to/from the distributed execution managers 222 of the compute nodes 200A-N), I/O requests (to/from the distributed I/O managers 224 of the compute nodes 200A-N), memory (to/from the distributed memory managers 226 within distributed memory space 626), updates to the distributed synchronization metadata 235 (disclosed in further detail herein), and so on.

The DCS 230A-N may further comprise a monitor 736 configured to, inter alia, monitor the load, performance and/or health of the respective compute nodes 200A-N. The monitor 736 may monitor the load on physical computing resources 101, capture performance profiling data, and/or monitor health metrics (e.g., temperature, faults, and/or the like). The monitor 736 may maintain and/or update load, health, and/or performance metadata for the respective compute nodes 200A-N by use of the distributed synchronization metadata 235.

The DCS 230A-N may further comprise a node manager 738 configured to manage, inter alia, admission and/or expulsion of compute nodes 200A-N from the distributed computing environment 111. The node manager 738 may be configured to admit a compute node 200A-N (e.g., the compute node 200N) by, inter alia, identifying the compute node 200N on the interconnect 115, authenticating and/or validating the compute node 200N, incorporating the compute node 200N into the distributed computing environment 111, updating the distributed synchronization metadata 235, and synchronizing the updated distributed synchronization metadata 235 within the distributed computing environment 111. Identifying the compute node 200N may comprise identifying network traffic from the compute node 200N on the interconnect 115 (e.g., receiving a join request). The network traffic may be directed to the particular compute node 200A and/or may comprise a broadcast message accessible to all of the compute nodes 200A-N communicatively coupled to the interconnect 115. Authenticating and/or validating the compute node 200N may comprise requesting, receiving and/or validating an authentication credential of the compute node 200N, establishing a secure communication channel to the compute node 200N, and/or the like. Incorporating the compute node 200N into the distributed computing environment 111 may comprise a) allocating and/or registering processing resources of the compute node 200N, b) allocating and/or registering I/O resources of the compute node 200N, c) allocating and/or registering memory resources of the compute node 200N, and so on. Allocating the processing resources of the compute node 200N may comprise identifying the processor(s) and/or processor core(s) available at the compute node 200N, registering processor state metadata 331A-N for the corresponding EEU 223A-N of the compute node 200N in the distributed processor emulation metadata 330, and so on. Allocating the I/O resources of the compute node 200N may comprise accessing physical I/O metadata for I/O devices of the compute node 200N, assigning virtual I/O metadata to the I/O devices, and/or registering the devices in the distributed I/O metadata 525, as disclosed herein (e.g., creating emulated I/I metadata entries 532 and/or physical I/O metadata entries 533 for the allocated devices). Allocating I/O resources may further comprise allocating storage resources of the compute node 200N for the distributed storage address space 540, updating the distributed storage metadata 535 to map the emulated storage addresses 542 of the distributed storage address space 540 to the local storage addresses 544 of the compute node 200N (specific storage blocks on the storage resources 108 of the compute node 200N). Allocating memory resources of the compute node 200N may comprise reserving memory resources 106 of the compute node 200N for the distributed memory space 626, registering the memory resources 106 in the distributed memory metadata 625 (e.g., to translate memory addresses within the distributed memory space 626 to physical memory addresses at the compute node 200N), and so on. Incorporating the compute node 200N may further comprise transmitting the updated distributed synchronization metadata 235 to the compute node 200N, and verifying that the compute node 200N has applied the updated distributed synchronization metadata 235 and is ready to receive requests to execute instructions, access I/O devices, and/or manipulate memory within the distributed computing environment 111, as disclosed herein.

In response to incorporating the compute node 200N into the distributed computing environment 111, the metadata synchronization engine 734 may transmit one or more metadata synchronization messages 237 to other compute nodes 200A-N to indicate that the compute node 200N has been admitted into the distributed computing environment 111. The metadata synchronization messages 237 may be further configured to indicate the computing resources of the compute node 200N that have been incorporated into the distributed computing environment 111 (e.g., identify new processing resources of the distributed processor emulation metadata 330, new I/O devices of the distributed I/O metadata 525, new memory addresses in the distributed memory metadata 625, and so on).

The node manager 738 may be further configured to manage eviction of a compute node 200A-N from the distributed computing environment 111 (e.g., eviction of compute node 200N). A compute node 200N may be evicted in response to one or more of a) a request to leave the distributed computing environment 111, b) failure of the compute node 200N, c) load, health, and/or performance metrics of the compute node 200N, d) licensing, and/or the like. Eviction of the compute node 200N may comprise a) deallocating and/or deregistering resources of the compute node 200N and b) synchronizing the distributed synchronization metadata 235 to the remaining compute nodes 200A-N. Deallocating resources of the compute node 200N may comprise one or more of removing processing resources from the distributed processor emulation metadata 330, removing I/O devices from the distributed I/O metadata 525, and removing memory addresses from the distributed memory metadata 625. Deallocating resources may further comprise transferring contents and/or state from resources of the compute node 200N (e.g., to the compute node 200A). Deallocating processing resources of the compute node 200N may comprise transferring processor state metadata 331A-N of the compute node 200N into the compute node 200A and/or updating references to the EEU 223A-N of the compute node 200N to reference EEU 223A-N at the compute node 200A. Deallocating I/O resources of the compute node 200N may comprise transferring I/O state data (e.g., buffer data, input data, output data and/or the like) from the compute node 200N to the compute node 200A and/or updating references to the I/O devices in the distributed I/O metadata 525. Deallocating I/O resources may further comprise deallocating emulated storage addresses 542 of the distributed storage address space 540 that correspond to local storage addresses 544 on the compute node 200N. Deallocating the storage resources may further comprise transferring data stored at the compute node 200N to one or more other compute nodes 200A-N, and/or updating the distributed storage metadata 535 to reference the transferred data. Deallocating memory resources of the compute node 200N may comprise transferring contents of the memory resources 106 of the compute node 200N to memory resources 106 of the compute node 200A and/or updating translations of the distributed memory metadata 625 to reference the transferred memory.

In some embodiments, one of the compute nodes 200A-N may be designated as a master compute node (e.g., the compute node 200A). The master compute node 200A may be configured to manage admission into the distributed computing environment 111 and/or eviction from the distributed computing environment 111, as disclosed herein. The master compute node 200A may process requests to join and/or leave the distributed computing environment 111 (requests 737). Such requests 737 may be ignored by compute nodes 200B-N that are not currently operating as the master. The master compute node 200A may be further configured to maintain and synchronize the distributed synchronization metadata 235 to the other compute nodes 200B-N. The other compute nodes 200B-N may be configured to receive and/or transmit metadata synchronization messages 237 within the distributed computing environment 111 via the interconnect 115, as disclosed herein. The master compute node 200A may ensure coherency of the distributed synchronization metadata 235 by, inter alia, selectively locking and/or synchronizing portions of the distributed synchronization metadata 235 being actively updated by various compute nodes 200A-N in the distributed computing environment 111.

The master compute node 200A may be specified in the distributed synchronization metadata 235 synchronized to the compute nodes 200A-N. In some embodiments, the master compute node 200A designates a backup master compute node 200B-N that is configured to act as master under certain conditions, such as failure of the master compute node 200A, high load on the master compute node 200A, low health and/or performance metrics for the master compute node 200A, and/or the like.

In some embodiments a plurality of compute nodes 200A-N may be configured to operate as a master for particular portions of the synchronization metadata 225. In one embodiment, for example, the DCM 110 of the compute node 200A may be configured to operate as a master for computing operations pertaining to application(s) hosted within the host environment 112 thereof (e.g., computing operations of the guest 130). The DCS 230A of compute node 200A may, therefore, be configured to manage, inter alia: a) distributed processor emulation metadata 225 pertaining to executable instructions of the guest 130, b) distributed I/O metadata 525 pertaining to I/O requests of the guest 130, c) distributed memory metadata 625 pertaining to memory accesses of the guest 130 (e.g., regions of the distributed memory space 626 allocated to the guest 130), d) distributed storage metadata pertaining to storage operations of the guest 130, and so on. As disclosed herein, managing the synchronization metadata 225 may comprise, inter alia, distributing updates to the synchronization metadata 225 to other compute nodes 200B-N, incorporating updates to the synchronization metadata 225 from other compute nodes 200B-N, managing lock(s) on portions of the synchronization metadata 225, and so on. Other compute nodes 200B-N may be configured to act as a master for other portions of the synchronization metadata 235. The compute node 200B may, for example, operate as a master for synchronization metadata 235 pertaining to a guest (not shown) operating within the host environment 112 thereof.

Although a particular scheme for designating a plurality of master compute nodes 200A-N is described herein, the disclosure is not limited in this regard and could be adapted to incorporate a plurality master compute nodes 200A-N according to any suitable segmentation scheme. For example, in another embodiment, the distributed computing environment may comprise a plurality of master compute nodes 200A-N, each assigned to manage a particular type of synchronization metadata 235. In such an embodiment, the compute node 200A may be designated to manage distributed processor emulation metadata 225, the compute node 200B may be designated to manage distributed I/O metadata 525, the compute node 200N may be designated to manage distributed memory metadata 625, and so on. Each of the plurality of master compute nodes 200A-N may further comprise a designated backup master compute node 200A-N configured to replace a respective master compute node 200A-N under certain conditions, as disclosed herein (e.g., failure of the respective master compute node 200A-N).

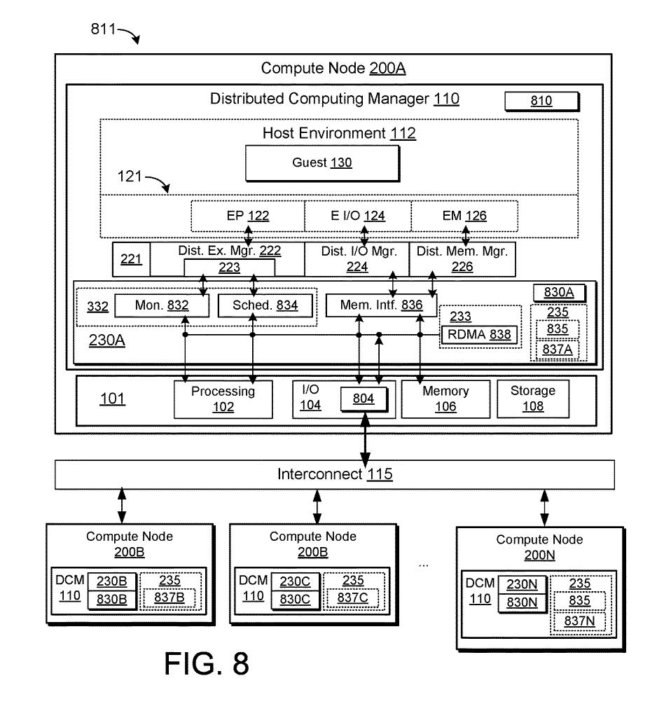

FIG. 8 is a block diagram of another embodiment of a cluster 811 comprising a plurality of compute nodes 200A-N, each comprising a DCM 110 and respective DCS 230A. The compute nodes 200A-N of the cluster 811 may be configured to operate in a distributed computing environment 111 as disclosed herein. As illustrated in FIG. 8, the DCS 230A may comprise a monitor 832, scheduler 834, memory interface 836, and messaging engine 233. The messaging engine 233 may be communicatively coupled to the interconnect 115 via, inter alia, a network interface device. In the FIG. 8 embodiment, the messaging engine 233 comprises an RDMA client/server 838. The messaging engine 233 may, therefore, be configured to transmit messages to other compute nodes 200B-N as an RDMA server, and may receive messages from other compute nodes 200B-N as an RDMA client. The RDMA client/server 838 may implement RDMA communication via the interconnect 115 and by use of a network interface 804 of the compute node 200A.

The monitor 832 and/or scheduler 834 may replace and/or modify a monitor and/or scheduler of a local operating system of the compute node 200A. Similarly, the memory interface 836 may modify and/or replace a memory and/or I/O interface of the local operating system of the compute node 200A. The EEU 223 of the distributed execution manager 222 may be communicatively coupled to the monitor 832 and/or scheduler 834 of the distributed execution scheduler 332. The monitor 832 may be configured to receive instructions 303 fetched and/or decoded by the distributed execution manager 222 and may, inter alia, assign the instructions 303 to respective EEU 223A-N on the compute node 200A and/or on other compute nodes 200B-N (by use of the scheduler 834). As disclosed above, the instructions 303 may be assigned based on an instruction assignment criterion, which may correspond to whether the instructions 303 reference memory and/or I/O local to the compute node 200A (or other compute node 200B-N), load, health, and/or performance metrics of the compute nodes 200A-N, and/or the like. The monitor 832 may be configured to execute instructions at the compute node 200A by use of a respective EEU 223 and/or the processing resources 102 of the compute node 200A. The monitor 832 and/or scheduler 834 may be further configured to distribute the instructions 303 for execution on a remote compute node 200B-N by use of the messaging engine 233. In the FIG. 8 embodiment, the messaging engine 233 comprises the RDMA client/server 838 configured to, inter alia, perform RDMA operations between the compute node 200A and other compute nodes 200B-N in the cluster 811.

The memory interface 836 may be configured to route I/O and/or memory access requests to respective compute nodes 200A-N. The memory interface 836 may identify I/O and/or memory requests that can be serviced at the compute node 200A by use of the distributed synchronization metadata 235, as disclosed herein. More specifically, the memory interface 836 may identify I/O requests directed to devices at the compute node 200A by use of the distributed I/O metadata 525 (e.g., using the emulated I/O addresses and/or identifiers assigned to the I/O devices in the distributed I/O metadata 525 and presented through the emulated I/O 124). I/O requests that translate to physical I/O addresses at the compute node 200A may be serviced using the I/O resources 104 of the compute node 200A, as disclosed herein. I/O requests that translate to a remote compute node 200B-N may be forwarded to the remote compute node 200B-N via the interconnect 115 by use of the messaging engine 233 (e.g., the RDMA client/server 838).

The DCM 110 may further comprise a management interface 810, which may be configured to, inter alia, provide an interface for managing the configuration of the compute node(s) 200A-N of the cluster 811. The management interface 810 may comprise any suitable interface including, but not limited to: an application programming interface (API), a remote API, a network interface, a text interface, a graphical user interface, and/or the like. The management interface 810 may enable an administrator of the cluster 811 to perform management functions, which may include, but are not limited to: adding compute node 200A-N, removing compute node 200A-N, managing synchronization metadata 235 of the cluster 811, designating master compute node(s) 200A-N, designating backup master compute node(s) 200A-N, managing the emulated processor 122, managing emulated I/O resources 124, managing emulated memory resources 126, managing storage resources, monitoring the performance and/or health of the compute nodes 200A-N, and so on. Managing the emulated processor 122 of the cluster 811 may comprise, inter alia, defining and/or initializing distributed processor state metadata 225 that defines the processing architecture, configuration, and/or state of the emulated processor 122. Managing the emulated I/O resources 124 of the cluster 811 may comprise registering and/or de-registering physical I/O resources of the compute nodes 200A-N in the distributed I/O metadata 525, as disclosed herein. Managing the emulated memory resources 126 of the distributed computing environment may comprise managing the distributed memory space 626 by, inter alia, managing translations between addresses of the distributed memory space 626 and physical memory resources 106 of the respective compute nodes 200A-N (e.g., configuring portion(s) of the physical memory address space of a compute node 200A-N or use as emulated memory resources 126, as disclosed herein). Managing the emulated storage resources of the distributed computing environment 525 may comprise registering and/or de-registering storage resources of the respective compute nodes 200A-N. Managing the synchronization metadata 235 may comprise designating master compute node(s) 200A-N to managing particular portions of the synchronization metadata 235. Managing the synchronization metadata 235 may further comprise configuring a messaging and/or communication protocols for use in distributing the synchronization metadata 235 to the compute nodes 200A-N (e.g., specify network addresses, ports, and/or protocols for communicating metadata synchronization messages 237 within the cluster 811).

In some embodiments, the management interface 810 is configured for operation on a subset of the compute nodes 200A-N of the distributed computing environment. The management interface 810 may, for example, be configured to operate on one or more master compute nodes 200A-N. Alternatively, the management interface 810 may be configured to operate any of the compute node(s) 200A-N, and management operations performed thereon may be distributed to the compute nodes 200A-N by use of metadata synchronization messages 237 and/or through other master compute node(s) 200A-N, as disclosed herein. Although particular functions of the management interface 810 as described herein, the disclosure is not limited in this regard and could incorporate management interface(s) 810 to manage and/or monitor any aspect of the cluster 811.

As disclosed above, the synchronization metadata 235 may be synchronized between the compute nodes 200A-N of the cluster 811. As disclosed herein, the DCM 110 of the respective compute nodes 200A-N may be configured to manage accesses to the synchronization metadata 235 to enable concurrent access by a plurality of different compute nodes 200A-N. The DCM 110 may ensure consistency by, inter alia, transmitting and/or receiving metadata synchronization messages 237 through the interconnect 115.

In the FIG. 8 embodiment, each of the DCS 230A-N of the compute nodes 200A-N comprises a respective synchronization engine 830A-N configured to manage accesses to the synchronization metadata 235. The synchronization engine 830A-N may be configured to ensure consistency of the synchronization metadata 225 within the cluster 811, which may comprise, inter alia: identifying and preventing data hazards (e.g., read after write, write after read, and the like), identifying and preventing structural hazards, identifying and preventing control hazards, and so on. The synchronization engine 830A-N may be configured to ensure consistency of the synchronization metadata 235 within the cluster 811 by, inter alia, managing exclusive access to portions of the synchronization metadata 235 by respective compute nodes 200A-N, receiving updates to the synchronization metadata 235 from the compute nodes 200A-N, distributing updates to the synchronization metadata 235 from the compute nodes 200A-N, and so on. The synchronization engine 830A-N may be configured to manage the consistency of various portions, section, or regions of the synchronization metadata 235 including, but not limited to: the distributed processor emulation metadata 225, the distributed I/O metadata 525, the distributed memory metadata 625, distributed storage metadata (if any), and so on. The synchronization engine 830A-N may be further configured to manage configuration data pertaining to the cluster 811, such as metadata pertaining to the compute nodes 200A-N admitted into the cluster (e.g., interconnect addressing, monitoring metadata, such as performance, load, and health, and so on, as disclosed herein).

The synchronization engine 830A-N may be further configured to prevent structural and/or control hazards within the emulated processor 122. As disclosed above, the emulated processor 122 is defined by distributed processor emulated metadata 225 that is shared, and synchronized, within the cluster 811. Accordingly, each compute node 200A-N is configured to emulate execution on the same instance of the same emulated processor 122. The synchronization engine 830A-N may manage the distributed processor emulation metadata 225 to ensure consistency of the metadata that defines the architecture, configuration, and/or operating state of the emulated processor 122. The synchronization engine 830A-N may manage read, write, and/or modification operations to the distributed processor emulation metadata 225 to prevent data hazards, structural hazards, control hazards, and/or the like. As disclosed herein, the synchronization engine 830A-N may maintain consistency metadata 835 pertaining to emulated data storage of the emulated processor 122, such as registers, cache data, queues, and so on. The synchronization manager 830A-N may monitor access to such portions of the distributed processor emulation metadata 225 to ensure data processor emulation data being accessed by a particular compute node 200A-N is not inappropriately overwritten by another compute node 200A-N (e.g., prevent write-before-read hazards within the distributed processor emulation metadata 235). The synchronization manager 830A-N may be further configured to monitor accesses to metadata that defines the configuration and/or operating state of the emulated processor 122 to prevent structural and/or control hazards. The synchronization manager 830A-N may be configured to monitor access to distributed processor emulation metadata 225 pertaining to control and/or state, such an instruction queue, execution pipeline, execution unit (ALU, FPU), control unit, buffers, and/or the like, to ensure that accesses are consistent with emulated execution on a single instance of the emulated processor 122. The synchronization engine 230A-N may, for example, prevent modifications to distributed processor emulation metadata 225 pertaining to the state of an ALU of the emulated processor 122 by a compute node 200A, while another compute node 200N is emulating execution of an instruction that involves access to the ALU of the emulated processor 122. Similarly, the synchronization engine 230A-N may stall emulated execution of a particular instruction at the compute node 200A until emulated execution of another instruction, which is to modify distributed processor emulation metadata 225 pertaining to the particular instruction, is completed at a different compute node 200N.

The synchronization engine 830A-N may be configured to service requests to access portion(s) of the synchronization metadata 235 for implementing a computing operations at a compute node 200A-N, by, inter alia: determining the type(s) of accesses to the synchronization metadata 235 to be performed in the computing operation, obtaining lock(s) on portion(s) of the synchronization metadata 235 in accordance with the determined type(s) of access, performing the computing operation at the compute node 200A-N, and releasing the lock(s) on the synchronization metadata 235 (if any). Determining the type(s) of access for implementing the computing operation may comprise evaluating the computing operation, which may include identifying metadata of the emulated processor 122 to be accessed, modified, and/or written for emulated execution of an instruction, identifying emulated I/O 124 to be accessed, modified, and/or written in the computing operation, identifying emulated memory 126 to be accessed, modified and/or written in the computing operation, identifying emulated storage to be accessed, modified and/or written in the computing operation, and so on. Determining the type(s) of access required for a computing operation may comprise identifying lock(s) to obtain to ensure consistency of the synchronization metadata 235, which may include, but are not limited to: a read lock, a write lock, a read-modify-write lock, and/or the like. In some embodiments, the type of access required for a computing operation may not be readily determined. In response, synchronization engine 830A-N may obtain an “undetermined” lock, which may be initially treated as a restrictive lock (e.g., a read-modify-write lock). During execution, the synchronization engine 830A-N may determine the specific type of lock required, and may modify the lock accordingly. As disclosed herein, modifying the lock may enable other computing operation to be performed concurrently (e.g., revising the lock to a read lock may enable another read lock to be granted).

In response to obtaining the lock(s) required for the computing operation from the synchronization engine 830A-N, the computing operation may be performed. Performing the computing operation may comprise accessing the synchronization metadata 235 in accordance with the obtained locks. The synchronization engine 830A-N may monitor the computing operation to ensure that accesses to the synchronization metadata 235 complies with the locks and may block requests that fall outside of the bounds thereof (e.g., a request to update a portion of the synchronization metadata 235 to which only a read lock was obtained). If one or more of the locks for the computing operation cannot be obtained, the synchronization engine 830A-N may return an indication that the computing operations must be delayed (and/or may suspend its response to the access request until the locks can be obtained). In some embodiments, the synchronization engine 830A-N maintains a queue of lock requests for various portions of the synchronization metadata 235 and may service requests in the queue to, inter alia, prevent deadlocks, enable concurrency and parallelism, while ensuring metadata consistency and deterministic execution.

In some embodiments, the synchronization engine 830A-N manages metadata consistency by use of concurrency metadata 835. The concurrency metadata 835 may identify locks on portions of the synchronization metadata 235, may comprise queue(s) of lock requests, and so on, as disclosed herein. In some embodiments, the consistency metadata 835 is included in the synchronization metadata 235, such that each compute node 200A-N comprises a synchronized copy thereof. Alternatively, the consistency metadata 835 may be maintained by specific compute nodes 200A-N assigned to manage access to the synchronization metadata 235 (e.g., one or more master compute nodes 200A-N).

As disclosed herein, servicing emulated computing operations on the compute nodes 200A-N may comprise modifying the synchronization metadata 235 of the cluster 811. Accordingly, performing a computing operation may comprise generating delta metadata 837A-N at the compute node 200A-N. As used herein, “delta metadata” refers to metadata that defines modifications to the synchronization metadata 235 relative to a current version of the synchronization metadata 235. The current version of the synchronization metadata 235 may be maintained by the compute nodes 200A-N and/or a master compute node 200A-N, as disclosed herein. The synchronization engine 830A-N may be configured to distribute delta metadata 837A-N within the cluster such that consistency of the synchronization metadata 235 is maintained (e.g., by transmitting, receiving, and incorporating metadata synchronization messages 237, as disclosed herein). The synchronization engine 830A-N may be configured to incorporate delta metadata 837A-N to ensure consistency and deterministic update order. In some embodiments, each compute node 200A-N is configured to incorporate delta metadata 837A-N into an independent copy of the synchronization metadata 235 maintained thereby. Alternatively, incorporation of delta metadata 837A-N may be managed by one or more compute nodes 200A-N assigned to manage consistency of particular regions of the synchronization metadata 235 (e.g., master compute nodes 200A-N).

As disclosed herein, maintaining consistency of the synchronization metadata 235 may comprise obtaining lock(s) on portion(s) of the synchronization metadata 235 in accordance with the determined type(s) of access required to the respective portions (e.g., read-only access, read-write access, write access, undetermined access, and/or the like). In one embodiment, a request to write to emulated memory 126 may comprise obtaining a read lock on a portion of the emulated memory metadata 626 to determine the physical address(es) to be written (e.g., entries 627 and 629), and a write lock on the corresponding distributed memory addresses and/or physical memory resources 106. In another embodiment, a request to add or remove a compute node 200A-N may comprise write access to the emulated memory metadata 625 in order to, inter alia, manage the distributed memory space 626, to add or remove physical memory resources 106 (e.g., add remove entries 627 and/or 629), relocate contents of portions of the distributed memory space 626, and so on. In another embodiment, a computing operation to emulate execution of an instruction on the emulated processor 122 may comprise requesting a read lock on portion(s) of the distributed processor emulation metadata 225, such as registers to be read and/or accessed, structural metadata, control metadata and/or the like.

The synchronization engine 830A-N may be configured to analyze computing operations to be performed at the respective compute nodes 200A-N in order to determine the type(s) of locks required to ensure consistency of the synchronization metadata 235. Emulated execution of an instruction on the emulated processor 122 may comprise obtaining a plurality of different types of locks based on different types of potential hazard conditions. Accordingly, determining the type of access required for emulated execution of an instruction may comprise evaluating the instruction to identify and prevent data hazards, structural hazards, and/or control hazards within the emulated processor 122. Evaluating the instruction may comprise determining portions(s) of the emulated processor 122 to be read, written, and/or modified during emulated execution of the instruction, in order to: a) identify potential data hazards pertaining to emulated execution of the instruction (e.g., identify data storage of the emulated processor 122 to be read, written, and/or modified for emulation of the instruction), b) identify potential structural hazards pertaining to emulated execution of the instruction (e.g., identify metadata pertaining to structure of the emulated processor 122 to be read, written, and/or modified for emulation of the instruction), c) identify potential control hazards pertaining to emulated execution of the instruction (e.g., identify metadata pertaining to metadata pertaining to control elements of the emulated processor 122 to be read, written, and/or modified for emulation of the instruction), and so on. Determining the type of access to the distributed processor emulation metadata 225 required for emulation of the instruction may, therefore, comprise determining type of accesses to data, structural, and/or control elements of the emulated processor 122 for emulation of the instruction.

In some embodiments, determining the type of accesses comprises interpreting the instruction by, inter alia, determining an opcode(s) and/or processor operation(s) for the instruction. Interpreting the instruction may comprise decompiling the instruction from a binary or machine format into an intermediate format, as disclosed above. Determining the type of access required for instruction emulation may comprise determining sub-operations to be performed within the emulated processor 122 during emulated execution, which may comprise interpreting the instruction, decompiling the instruction, evaluating instruction opcodes, and/or the like. In one embodiment, an instruction may be decompiled to determine an instruction opcode which may specify a write operation to a particular register of the emulated processor 122. In response, the synchronization engine 830A-N may determine that emulation of the instruction requires a write lock on the portion of the distributed processor emulation metadata 525 that corresponds to the particular register. In another embodiment, interpretation of the instruction may comprise determining that the instruction reads the value of the particular register and, in response; the synchronization engine 830A-N may determine that emulated execution of the instruction requires a read lock on the portion of distributed processor emulation metadata 225 that corresponds to the particular register. In another embodiment, interpretation of the instruction may comprise determining that the instruction corresponds to a structural operation within a particular element of the emulated processor 122, such as an ALU, FPU, and/or the like. Emulation of the instruction may comprise accessing metadata pertaining to the current operating state of the structural element, such as such as intermediate values of a pipelined FPU, an iteration of a stream processing element, or the like. Interpreting the instruction may comprise determining that emulation of the instruction will comprise reading, modifying, and writing metadata pertaining to the operating state of the structural element of the emulated processor 122. In response, the synchronization engine 830A-N may determine that a read-modify-write lock is required on the portion of the distributed emulation metadata pertaining to the structural element of the emulated processor 122. In yet another embodiment, interpreting the instruction may comprise determining that the instruction pertains to a control element of the emulated processor, such as a branch predictor, instruction queue controller, cache controller, and/or the like. In response, the synchronization engine 830A-N may determine that emulation of the instruction requires a read, write, and/or read-modify-write lock on portions of the distributed emulation metadata pertaining to the control element.

In some embodiments, the type of access to the distributed processor emulation metadata 122 may depend upon a current state of the emulated processor 122 (e.g. the architecture, configuration, and/or operating state of the emulated processor 122 as defined by the synchronized distributed processor emulation metadata 225). Accordingly, determining the type of access required for emulation of the instruction may comprise “pre-emulating” execution of the instruction on the emulated processor 122. As used herein, “pre-emulation” refers to a preliminary emulation operation that simulates emulation of an instruction on a current instance of the emulated processor 122 without actually committing results of the emulation (if any). Accordingly, pre-emulation may comprise evaluating emulation of an instruction on a “read-only” version of the emulated processor 122 in which an effects of the instruction are not reflected in the distributed processor emulation metadata 122. Pre-emulation may, therefore, be referred to as “simulated emulation” or “read-only emulation.” Pre-emulation may comprise analyzing execution of the instruction based on the architecture, configuration, and/or operating state of the emulated processor 122 as defined in the distributed processor emulation metadata 225, which may comprise identifying read, write, and/or modification operations required for actual emulation of the instruction. Pre-emulation may be based on the architecture of the emulated processor 122, the configuration of the emulated processor 122, and/or the state of the emulated processor 122 (e.g., state of data storage elements, structural elements, control elements, and so on). In one embodiment, for example, the type of access to the distributed emulation metadata 225 may depend on the contents of a particular register of the emulated processor 122, the state of a structural element of the emulated processor 122 (e.g., state of a processing unit pipeline), the state of a control element of the emulated processor 122, and/or the like. Accordingly, analyzing an instruction to identify the access lock(s) required for concurrent emulation may comprise pre-emulating the instruction based on the current distributed processor emulation metadata 225 to identify accesses that will be made during emulated execution of the instruction on the emulated processor 122. Pre-emulation may comprise determining whether emulation of the instruction comprises operations to read, write, and/or update particular elements of the emulated processor 122, such as data storage elements, structural elements, and/or control elements, and/or the like.

In response to determining the access(es) to the distributed processor emulation metadata 225 required for emulation execution of the instruction on the emulated processor 122, the synchronization engine 830A-N may determine whether the determined access(es) have the potential to affect the consistency of the distributed processor emulation metadata 525 and/or may create a hazard with respect to other, concurrent emulation operations on the emulated processor 122 (e.g., a data hazard, a structural hazard, a control hazard, and/or the like). The determination of whether a hazard condition exists may determine, inter alia, which portions of the distributed emulation processor data 225 to lock (and the nature of such locks, if any) during emulated execution of the instruction. The synchronization engine 830A-N may tailor lock(s) on the distributed processor emulation metadata 225 based on, inter alia, the architecture and/or configuration of the emulated processor 122. In one embodiment, the synchronization engine 830A-N may determine that emulation of a first instruction may comprise accessing and/or updating the operating state of a particular element of the emulated processor, such as a particular processor core (e.g., pipelined FPU). The synchronization engine 830A-N may, therefore, determine that emulation of the first instruction requires a read-modify-write lock on the portion of the distributed processor emulation metadata 225 that pertains to the particular element of the emulated processor 122. The synchronization engine 830A-N may be further configured to determine that execution of a second instruction that accesses a different, independent FPU of the emulated processor 122 may be emulated concurrently with the first instruction (and may require a lock on the portion of the distributed processor emulation metadata 225 that pertains to the separate, independent processing element).

As disclosed above, the synchronization engine 830A-N may be configured to determine lock(s) required for emulated execution of instructions on the emulated processor by, inter alia, evaluating the instructions, decompiling the instructions, interpreting the instructions, evaluating instruction opcodes, pre-emulating the instructions, simulating emulation of the instructions, and/or the like, as disclosed herein. In response, the synchronization engine 830A-N may be configured to acquire the determined locks and emulate the instructions on respective EEU 223A-N. The determined locks may prevent emulation of the instruction from creating data, structural, and/or control hazards for other instructions being executed on the emulated processor 122 within the cluster 811. After acquiring the locks (if any), the compute node 200A-N may emulate execution of the instruction by use of an EEU 223A-N. During emulation of the instruction, the determined lock(s) may prevent data, structural, and/or control hazards due to other emulation operations being concurrently performed on compute nodes 200A-N and/or EEU 223A-N. Upon completion of emulated execution, the EEU 223A-N may synchronize delta metadata 837A-N comprising modifications to the distributed processor emulation metadata 225 (if any) through the synchronization engine 830A-N, and the synchronization engine 830A-N may incorporate the delta metadata 837 and release the determined lock(s) acquired for the instruction, as disclosed herein.

In some embodiments, the synchronization engine 830A-N is configured to manage synchronization operations for instruction emulation and/or assignment of instructions for emulation at particular compute nodes 200A-N using techniques the reduce synchronization overhead and improve performance while maintaining consistency. In one embodiment, the synchronization engine 830A-N is configured to a) identify related instructions, b) designate the related instructions for emulation at a particular compute node 200A-N, and c) to defer synchronization of certain portions of delta metadata 837A-N corresponding to emulated execution of the related instructions. As used herein, “related instructions” refer to instructions that require access to particular portion(s) of the distributed processor emulation metadata 225 such as, for example, instructions for emulated execution on a particular processing unit or core of the emulated processor 122. The synchronization engine 830A-N may be configured to identify related instructions by, inter alia, analyzing instructions being emulated within the cluster 811. Identifying related instructions may comprise determining the type of access to the distributed processor emulation metadata 225 required for emulation of a plurality of instructions, as disclosed herein. Identifying related instruction may comprise analyzing a plurality of instructions in an execution queue and/or before the instructions are been submitted for execution by the emulated processor 122 (e.g., stored instructions, instructions loaded into the distributed memory space 626, instructions on a stack or heap referenced by the emulated processor 122, and/or the like). As disclosed above, identifying a set of related instructions may comprise identifying instructions that require access to particular portions of the distributed processor emulation metadata 225, such as instructions for execution on a particular processing unit, core, or element of the emulated processor 122. Identifying related instructions may, for example, comprise identifying instructions of a single thread or process for execution on a particular core of the emulated processor 122. Identifying the related instructions may further comprise determining that the related instructions access portions of the distributed emulation metadata 225 that does not need to be accessed for emulated execution of other instructions on the emulated processor 122. The synchronization engine 830A-N may, in one embodiment, determine that the related instructions may be executed on a particular core of the emulated processor 122 and that other, unrelated instructions may be concurrently executed on other core(s) of the emulated processor 122.

In response to identifying the related instructions, the synchronization engine 830A-N may designate the related instructions for assignment to a particular compute node 200A-N and/or particular EEU 223A-N. In one embodiment, the synchronization engine 830A-N may designate a set of related instructions for emulated execution at compute node 200A. Designating the related instructions for emulation at the compute node 200A may further comprise acquiring a lock on the determined portion(s) of the distributed processor emulation metadata 225 to be accessed during emulated execution of the related instructions (e.g., a lock on distributed processor emulation metadata 225 pertaining to the particular core of the emulated processor 122 on which the related instructions are to be executed). The lock may correspond to a union of the distributed processor emulation metadata 225 accessed by the related instructions. Accordingly, the lock(s) for the related instructions may exceed the lock requirements of individual instructions in the set. In response to designating the related instructions for assignment to the compute node 200A, and acquiring the lock(s), the synchronization engine 830A-N may exclusively assign instructions of the related set of instructions to the compute node 200A. The compute node 200A may emulate execution of the assigned instructions, as disclosed herein. Emulation of the related instructions at the compute node 200A may comprise generating delta metadata 837A, which may comprise modifications to the locked portion(s) of the distributed processor emulation metadata 225. The synchronization engine 830A may be configured to defer synchronization of the modifications to the locked portion(s) of the distributed processor emulation metadata 225 to other compute nodes 200B-N of the cluster 811 while the compute node 200A emulates execution of the related instructions. While emulating execution of the related instructions, the compute node 200A may operate using a local, modified version the distributed processor emulation metadata 225, which includes the incremental changes made within the locked portion(s) thereof during emulated execution of the related instructions. During emulated execution of the related instructions, the synchronization engine 830A may configured to synchronize other delta metadata 837A of the compute node 200A that pertains to other, unlocked portions of the synchronization metadata 235 and/or incorporate updates to the synchronization metadata 235 from other compute nodes 200B-N, as disclosed herein. Deferring synchronization of the delta metadata 837A while the related instructions are being emulated at the compute node 200A may reduce the synchronization overhead of the cluster 811 and improve performance of the compute node 200A by, inter alia, reducing the load thereon. Since the deferred updates pertain to locked portions of the distributed processor emulation metadata 225, which are not required by the other compute nodes 200B-N, deferring synchronization may not violate consistency of the distributed processor emulation metadata 225 and/or create potential data, structural, and/or control hazards within the emulated processor 122. The synchronization engine 830A may be configured to synchronize the delta metadata 837A pertaining to execution of the related instructions at a later time and/or in response to a particular condition. In one embodiment, the synchronization engine 830A synchronizes the deferred delta metadata 837A in response to one or more of: completing emulated execution of the related instructions at the compute node 200A, identifying another unrelated instruction that requires access to the locked portion(s) of the distributed processor emulation metadata 225, expiration of a deferred synchronization threshold, and/or the like.

As disclosed above, the compute nodes 200A-N may be configured to coordinate synchronization operations within the cluster 811. In some embodiments, the compute nodes 200A-N are assigned to operate according to a particular role or mode, which may determine how synchronization operations are performed. In some embodiments, the synchronization engine 830A-N is configured to operate according to a particular mode, such as a master mode, a backup mode, a slave mode, or the like. In the master mode, the synchronization engine 830A-N may be configured manage concurrency of a particular region of the synchronization metadata 235. In some embodiments, master compute nodes 200A-N may be assigned to manage consistency of all of the synchronization metadata 235 of the cluster 811. Alternatively, master compute nodes 200A-N may be assigned to act as master for particular types of synchronization metadata 235, such as the distributed processor emulation metadata 235, distributed I/O metadata 525, distributed memory metadata 625, and so on. In some embodiments, master compute nodes 200A-N may be designated based on a particular criteria, such as a proximity metric. For example, each compute node 200A-N may be designated as the master for synchronization metadata 235 pertaining to physical computing resources 101 therefor, such as the synchronization metadata 235 pertaining to the physical processing resources 102, I/O resources 104, memory resources 106, and/or storage resources of the compute node 200A-N. Alternatively, or in addition, the master compute node(s) 200A-N may be assigned based on other criteria, such as proximity to other compute nodes 200A-N in the cluster 811, performance metrics, load metrics, health metrics, and/or the like. Although particular mechanisms for metadata synchronization within the cluster 811 as described herein, the disclosure is not limited in this regard and could incorporate any suitable metadata consistency and/or synchronization technique.

When operating in the master mode, the synchronization engine 830A-N may be configured to maintain consistency of the synchronization metadata 235 within the cluster 811, which may include, but is not limited to: receiving, incorporating, and/or distributing updates to the synchronization metadata 235, maintaining consistency of the synchronization metadata 235 during concurrent access by the compute nodes 200A-N, and so on. In the FIG. 8 embodiment, the synchronization engine 830A of compute node 200A may be configured to operate as a master for the cluster 811. As such, the synchronization engine 830A may be configured to maintain consistency metadata 835 to manage consistency of the synchronization metadata 235, as disclosed herein. The synchronization engine 830A may respond to requests to access and/or lock portions of the synchronization metadata 235, which may comprise determining lock(s) required to satisfy the request (if any), obtaining the determined lock(s) on the synchronization metadata 235, releasing the lock(s) in response to determining that the request has been completed, and so on. Releasing a lock on the synchronization metadata 235 may comprise incorporating delta metadata 837A-N corresponding to the lock (if any) into the synchronization metadata 235, distributing the updated synchronization metadata 235 within the cluster 811, and so on.

In the slave mode, the synchronization engine 830B-N may be configured to receive and/or incorporate updates to the synchronization metadata 235 from the master compute node 200A. Performing a computing operation at a slave compute node may comprise determining the access required for the computing operation (e.g., identifying portion(s) of the synchronization metadata 235 to be access and the type of access required), requesting access to portion(s) of the synchronization metadata 235 through synchronization engine 830A, performing the computing operation in response to obtaining the requested access, and releasing the access in response to completing the computing operation. Releasing the access to the synchronization metadata 235 may further comprise transmitting delta metadata 837A-N to the synchronization engine 830A that defines, inter alia, modifications to the synchronization metadata 235 resulting from the computing operation. In response, the synchronization engine 830A may incorporate the delta metadata 837A-N into the synchronization metadata 235, distribute updates within the cluster 811, and release the corresponding lock(s) on the synchronization metadata 235.

In some embodiments, the cluster 811 may further comprise compute node 200A-N assigned to act as a backup master. The assignment of backup master may be based on any suitable criteria including, but not limited to: proximity, performance, load, health, and/or the like, as disclosed herein. In the FIG. 8 embodiment, the compute node 200N is assigned as the backup master for compute node 200A. Accordingly, the synchronization engine 830N of the compute node 200N may be configured to operate in the backup master mode. In the backup master mode, the synchronization engine 830N may be configured to maintain a separate independent copy of the consistency metadata 835 managed by the synchronization engine 830A of the master compute node 200A. Accordingly, the compute node 200N may be capable of seamlessly transitioning to the master of the cluster 811. Transitioning to use of the compute node 200N as the master for the cluster 811 may comprise assigning the synchronization engine 830N of the compute node 200N to operate in the master mode using the concurrency state metadata 835, configuring the synchronization engine 830A of the compute node 200A to operate in a slave and/or backup mode, and configuring the compute nodes 200A-N to access the synchronization metadata 235 through the synchronization engine 830N of the new master compute node 200N. Transitioning to the master compute node 200N may further comprise designating a backup for the new master compute node 200N such as the former master compute node 200A.

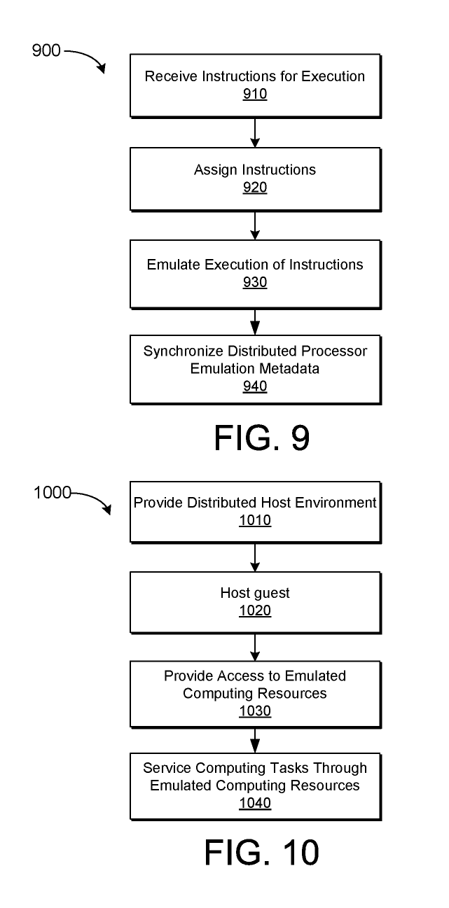

FIG. 9 is a flow diagram of one embodiment of a method 900 for distributed computing. Step 910 may comprise receiving one or more instructions 301 from a guest 130. Step 910 may comprise providing access to emulated processing resources to the guest 130 in an emulated host environment 112 (e.g., providing access to emulated processor 122, as disclosed herein). Step 910 may comprise receiving the one or more instructions 301 in response to the guest 130 performing a computing task within the host environment 112.

Step 920 may comprise assigning one of a plurality of compute nodes 200A-N to emulate execution of the instructions 301. Step 920 may comprise assigning a compute node 200A-N based on an execution assignment criterion, as disclosed herein. In some embodiments, step 920 may further comprise decompiling the instruction 301 to generate instructions 303 (e.g., opcode or pseudo code instructions). Step 920 may further comprise determining location(s) of computing resources required to emulate execution of the instructions 303, such as, for example, the physical location of memory referenced by the instructions 303, the physical location of I/O devices referenced by the instructions 303, and so on. Step 920 may further comprise evaluating one or more of load metrics, performance metrics, and/or health metrics of the compute nodes 200A-N.

As disclosed above, assigning instructions for emulation at particular compute nodes 200A-N at step 920 may comprise evaluating an assignment criterion by, inter alia, the distributed execution scheduler 332 of the compute node 200A-N. The assignment criterion may be defined in the synchronization metadata 235 of the cluster 811. Accordingly, each of the compute nodes 200A-N may be configured to assign instructions for execution based on the same and/or equivalent assignment criterion. Alternatively, each of the compute nodes 200A-N may utilize a separate, independent assignment criterion.

In some embodiments, evaluating the assignment criterion comprises a) determining one or more metrics for the compute nodes 200A-N, and b) assigning instruction(s) to the compute nodes 200A-N in accordance with the determined metrics. Step 920 may, therefore, comprise determining one or more metrics for the compute nodes 200A-N, which may include, but are not limited to: a proximity metric, a load metric, a performance metric, a health metric, and/or the like. Step 920 may comprise selecting the compute node 200A-N to assign to the instruction(s) based on the determined metrics. Step 920 may further comprise combining and/or weighting the metric(s) of the compute nodes 200A-N, comparing the metrics to respective thresholds, and/or the like.

As used herein, a “proximity metric” of a compute node 200A-N refers to a metric that quantifies a proximity of a compute node 200A-N to computing resources required for emulation of a particular instruction. The proximity metric may be based on one or more of “physical proximity,” “emulated proximity,” “performance proximity,” “synchronization proximity,” and/or the like. Physical proximity may refer to a physical location of the compute node 200A-N relative to the computing resources. The physical proximity may indicate, for example, that computing resources referenced by the instruction are local to the particular compute node 200A-N. Alternatively, physical proximity may indicate a physical proximity of the compute node 200A-N to the compute node(s) 200A-N at which the computing resources of the particular instruction are hosted (e.g., same rack, same building, etc.). Alternatively, or in addition, physical proximity may refer to a network topology of the cluster 811; the physical proximity of a compute node 200A-N to a particular resource may, for example, be based on network route between the compute node 200A-N and the resource (e.g., a length of the route, the number of hops, number of intervening devices, and/or the like). The “emulated proximity” of a compute node 200A-N to a particular instruction may refer to a proximity between the emulated computing resources of the particular instruction to the emulated computing resources of the compute node 200A-N. For example, the emulated proximity of a compute node 200A-N may be based on a proximity, within the distributed memory space 626, of memory addresses referenced by the particular instruction to memory addresses that map to the physical memory resources 106 of the compute node 200A-N. Accordingly, emulated proximity may indicate the likelihood that subsequent instructions will reference computing resources that are local to the particular compute node 200A-N. The “performance proximity” refers to observed and/or measured performance metrics for computing operations between particular compute nodes 200A-N. Performance proximity may quantify current load conditions within the distributed computing environment 111. Step 920 may, for example, comprise determining the latency for network communication between particular compute nodes 200A-N, which may vary depending on current load conditions of the compute nodes 200A-N, utilization of the interconnect 115, and so on. The performance proximity of a particular compute node 200A to computing resources hosted at another compute node 200B may, therefore, be based on monitored performance characteristics for communication between the particular compute nodes 200A and 200B. The “synchronization proximity” may quantify the proximity of the particular compute node 200A-N to the compute node 200A-N assigned to manage synchronization metadata 235 pertaining to the particular instruction (e.g., the master compute node 200A-N for the particular instruction and/or emulated resources referenced by the instruction). The synchronization proximity may be based on one or more of the physical proximity, emulated proximity, and/or performance proximity between the particular compute node 200A-N and the compute node 200A-N assigned to manage the synchronization metadata 235 pertaining to the particular instruction. The synchronization metric of a particular compute node 200A-N may, for example, be based on the performance of and/or load on communication link between the particular compute node 200A-N and the compute node 200A-N designated to manage the synchronization metadata 235 pertaining to the instruction.

A “load metric” of a compute node 200A-N may quantify the utilization and/or availability of physical computing resources 101 of the compute node 200A-N. The load metric of a compute node 200A-N may, for example, indicate the availability of processing resources 102 (e.g., availability of EEU 223A-N), availability of communication bandwidth to/from the compute node 200A-N, and so on. A “performance metric” may quantify performance characteristics of a compute node 200A-N such as, inter alia, an IOPs rate of the compute node 200A-N, operations-per-second (OPS), an emulated-instructions-per-second (EIPS) metric, communication latency, metadata synchronization latency, and/or the like. The performance metric of a compute node 200A-N may be based, at least in part, on physical characteristics the physical computing resources of the compute node 200A-N (e.g., processing resources 102, I/O resources 104, memory resources 106, and/or the like). Alternatively, or in addition, performance metrics may be based on observed performance of the compute nodes 200A-N in response to computing tasks assigned thereto. The “health metric” of a compute node 200A-N may quantify the operating conditions or “health” of the compute node 200A-N. The health of a compute node 200A-N may be based on any suitable criteria including, but not limited to: operating temperature, error rate (e.g., memory error rate, storage error rate, I/O error rate), crash history, and/or the like.

As disclosed above, assigning instructions to particular compute nodes 200A-N may comprise determining one or more of the metrics disclosed herein, evaluating and/or comparing the metric(s), and selecting compute nodes 200A-N to assign to the instruction(s). Step 920 may further comprise comparing metrics to one or more thresholds. For example, a compute node 200A-N may be removed from consideration for assignment to a particular instruction in response to determining that one or more metric of the compute node 200A-N fails to satisfy a particular threshold (e.g., load metric of the compute node 200A-N exceeds a threshold). Step 920 may further comprise combining and/or weighting metrics of the compute nodes 920 to determine an aggregate metric, and assigning instructions to be compute nodes 920 in accordance with the respective aggregate metrics. Alternatively, or in addition, step 920 may comprise a load-balancing assignment scheme in which instructions are distributed to compute nodes 200A-N having metrics within a particular range (e.g., that satisfy an acceptability threshold) in order to, inter alia, avoid overloading particular compute nodes 200A-N.

In some embodiments, step 920 comprises identifying a set of related instructions, as disclosed herein. Identifying a set of related instructions may comprise analyzing instructions to be executed on the emulated processor 122 to identify instructions that pertain to the same portion(s) of the distributed processor emulation metadata 225 (e.g., instructions for execution on a particular core of the emulated processor 122). The identified set of related instructions may be designated for assignment to a particular compute node 200A-N based on any of the assignment criteria disclosed herein (e.g., proximity, load metrics, and/or the like). Designating the related of instructions for assignment to the particular compute node 200A-N may further comprise acquiring lock(s) on portions of the distributed emulation metadata 225 to be accessed during emulated execution of the related set of instructions. The lock(s) correspond to a union of the accesses locks required for emulated execution of the set of related instructions and, as such, may exceed the lock requirements of specific instructions in the set of related instructions.

Step 930 may comprise emulating execution of the one or more instructions 301 at the compute node 200A-N assigned at step 920. Step 930 may comprise accessing distributed processor emulation metadata 225. As disclosed above, the processor emulation metadata 225 may define the architecture, configuration, and/or operating state of the emulated processor 122. The distributed processor emulation metadata 225 of step 930 may be synchronized between the compute nodes 200A-N, such that each compute node 200A-N is configured to emulate the same instance of the same emulated processor 122. Step 930 may further comprise emulating execution of the instructions 301 at the assigned compute node 200A-N by use of a selected emulated execution unit 223A-N. The selected emulated execution unit 223A-N may emulate the instructions 301 by use of a physical processor core 302A-N assigned thereto. Emulating execution of the instructions 301 may further comprise updating the distributed processor emulation metadata 225 that defines the emulated processor 122 (e.g., updating register values, updating an execution pipeline, and/or the like), accessing emulated I/O 124, accessing emulated memory 126, and/or the like, as disclosed herein.

In some embodiments, step 930 may comprise identifying metadata accesses required for emulated execution of the instruction, and acquiring locks for the identified metadata accesses (e.g., through the synchronization engine 830A-N). Step 930 may comprise a) identifying portions of the distributed processor emulation metadata 225 to lock during emulation of the instructions 301, b) requesting a lock on the identified portions (e.g., through a synchronization engine 830A-N and/or designated master compute node 200A-N), and c) emulating execution of the instructions in response to being granted the lock(s) on the identified portions. Identifying portions of the distributed processor emulation metadata 225 to lock may comprise identifying portions of the distributed processor emulation metadata 225 to be accessed, modified, and/or otherwise manipulated during emulation of the instructions 301.

In some embodiments, step 930 comprises analyzing the instruction to identify lock(s) required for emulated execution of the instruction 301. Step 930 may comprise analyzing the instruction 301 in order to identify and prevent data, structural, and/or control hazards pertaining to the emulated processor 122. Step 930 may comprise pre-emulating the instruction on the emulated processor 122. As disclosed above, the particular data, structural, and/or control elements of the emulated processor 122 to be accessed and/or modified by emulation of the instruction may be based on the current architecture, configuration, and/or operating state of the emulated processor 122 as defined in the current distributed processor emulation metadata 225. Accordingly, pre-emulating the instruction may comprise simulating emulation of the instruction on the emulated processor 122 to identify the particular elements of the emulated processor 122 to be accessed and/or modified during actual emulation of the instruction on an EEU 223A-N. The pre-emulation may determine lock(s) required to ensure consistency of the distributed processor emulation metadata 225 in accordance with the current architecture, configuration, and operating state of the emulated processor 122. Analyzing instructions at step 930 may comprise identifying related instructions for assignment to a particular compute node 200A-N, as disclosed herein.

Step 930 may further comprise emulating computing resources that span a plurality of compute nodes 200A-N of the distributed computing environment 111. The emulation operations of step 930 may be implemented in response to obtaining lock(s) on the synchronization metadata 235, as disclosed herein. Emulating execution of the instructions at step 930 may, therefore, further comprise a) providing access to emulated I/O resources 124 that span I/O resources 104 of the compute nodes 200A-N, b) servicing I/O requests at particular compute nodes 200A-N in accordance with the distributed I/O metadata 525, c) providing a shared, distributed memory space 626 that spans the memory resources 106 of the compute nodes 200A-N, d) servicing memory access requests at respective compute nodes 200A-N in accordance with the distributed memory metadata 625, and so on. Step 930 may, therefore, comprise servicing I/O request(s) on one or more of the compute nodes 200A-N, servicing memory access request(s) on one or more of the compute nodes 200A-N, servicing storage request(s) on one or more of the compute nodes 200A-N, and so on.

Step 940 may comprise synchronizing the distributed processor emulation metadata 225 in response to emulating execution of the instructions 301 at the assigned compute node 200A-N. Step 940 may comprise transmitting one or more metadata synchronization messages 237 to the compute nodes 200A-N. Alternatively, or in addition, step 940 may comprise transmitting a metadata synchronization message 237 to a designated master compute node 200A-N, which may synchronize the distributed processor emulation metadata within the distributed computing environment 111, as disclosed herein. Step 940 may further comprise releasing one or more locks on portions of the distributed processor emulation metadata 225, as disclosed herein. Alternatively, in some embodiments, synchronization of metadata updates pertaining to portions of the distributed processor emulation metadata 225 corresponding to emulated execution related instructions at a designated compute node 200A-N may be deferred, as disclosed herein.

Step 940 may further comprise managing other types of synchronization metadata 235, such as distributed I/O metadata 525, distributed memory metadata 625, distributed storage metadata, and so on. Step 940 may comprise, inter alia, locking portions of the synchronization metadata 235, distributing updates to the synchronization metadata 235 within the distributed computing environment 111, receiving updates to the synchronization metadata 235 from compute nodes 200A-N, and so on. In some embodiments, step 940 comprises operating as a master compute node for portions of the synchronization metadata 235. Operating as the master compute node may comprise managing locks on the synchronization metadata 235 by various compute nodes 200A-N, synchronizing updates to the compute nodes 200A-N, incorporating updates to the synchronization metadata 235 from the compute nodes 200A-N, and the like.

FIG. 10 is a flow diagram of another embodiment of a method 1000 for distributed computing. Step 1010 may comprise providing a host environment 112 for a guest 130. The host environment 112 may comprise managing a set of emulated computing resources 121 for the guest 130. As disclosed herein, the emulated computing resources 121 may include, but are not limited to: emulated processing resources (e.g., an emulated processor 122), emulated I/O resources (e.g., emulated I/O 124), emulated memory resources (e.g., emulated memory 126 including a distributed memory space 626), emulated storage, and so on. The emulated computing resources 121 may span the plurality of compute nodes 200A-N of the distributed computing environment 111, such that portions of the emulated computing resources 121 correspond to physical computing resources 101 of different respective compute nodes 200A-N. Step 1010 may, however, comprise presenting the emulated computing resources 121 within the host environment 112 such that the emulated computing resources 121 correspond to a single, unitary computing system having a single processor (emulated processor 122), a contiguous I/O address space (through emulated I/O 124), a contiguous memory space (distributed memory space 626), and so on. As disclosed above, step 1010 may comprise managing synchronization metadata 235 between the compute nodes 200A-N in order to, inter alia, maintain a consistent state of the emulated computing resources 121 within the distributed computing environment 111.

Step 1010 may comprise initializing the compute nodes 200A-N of the distributed computing environment 111 which may include loading a distributed computing manager 110 on a plurality of compute nodes 200A-N. As disclosed herein, the distributed computing manager 110 may comprise an emulation kernel that replaces and/or extends an operating system of the respective compute nodes 200A-N. In some embodiments, the distributed computing manager 110 extends and/or replaces one or more components of the base operating system, such as the network stack (TCP/IP stack), scheduler, shared memory system, CPU message passing system, APIC, and/or the like. Step 1010 may further comprise initializing synchronization metadata 235 within the distributed computing environment 111, which may include, but is not limited to: establishing distributed processor emulation metadata 225 that defines a single emulated processor 122 (and operating state thereof) shared by the compute nodes 200A-N, registering I/O resources 104 of the compute nodes 200A-N in distributed I/O metadata 525, registering memory resources 106 of the compute nodes 200A-N in distributed memory metadata 625, registering storage resources of the compute nodes 200A-N in distributed storage metadata, and so on. As disclosed herein, registering processing resources 102 may comprise assigning processing core(s) to respective emulated execution units 223A-N of the compute node 200A-N, registering I/O resources 104 may comprise assigning virtual identifier(s) and/or virtual I/O addresses of physical I/O resources 104 of the compute nodes 200A-N, mapping the virtual identifier(s) and/or virtual I/O addresses to the local I/O identifiers and/or addresses of the compute nodes 200A-N, and so on; registering memory resources 106 may comprise defining a distributed memory space 626 comprising virtual memory addresses that map to respective physical memory addresses of the compute nodes 200A-N through, inter alia, distributed memory metadata 626; registering storage resources may comprise assigning virtual block identifier(s) to storage resources of the compute nodes 200A-N, and mapping the virtual block identifier(s) to respective local block identifier(s) of the compute nodes 200A-N, and so on. Step 1010 may further comprise managing synchronization metadata 235 shared by the compute nodes 200A-N by one or more master(s), as disclosed herein.

Step 1010 may further comprise managing a distributed boot environment for guest(s) 130 operating on the respective compute nodes 200A-N. Step 1010 may comprise providing a boot manager 221 on each of the compute nodes 200A-N. The boot manager 221 may comprise a BIOS managed by a boot strap processor (BSP) operating on one or more of the compute nodes 200A-N.

Step 1020 may comprise hosting a guest 130 within the host environment 112 of a particular compute node 200A-N (e.g., compute node 200A). Step 1020 may, therefore, comprise booting the guest 130 within the host environment 112 by use of the boot manager 221.

Step 1030 may comprise providing access to the emulated computing resources 121 of the host environment 112. As disclosed herein, the emulated computing resources 121 may comprise an emulated processor 122, emulated I/O 124, emulated memory 126, and so on. The emulated processor 122 may emulate a single processor. Instructions issued to the emulated processor 122, however, may be distributed for execution to different compute nodes 200A-N. The architecture, configuration, and/or state of the emulated processor 122 may be defined by, inter alia, distributed processor emulation metadata 225, which may be synchronized between the compute nodes 200A-N, such that each compute node 200A-N may be configured to emulate the same instance of the emulated processor 122. Therefore, instructions of the guest 130 may appear to be emulated by the same instance of the same emulated processor even if the instructions are distributed for execution to different compute nodes 200A-N. The emulated I/O resources 124 may comprise a contiguous set of emulated IO resources, which may be referenced through, inter alia, emulated I/O identifier(s). The DCM 110 may manage the emulated I/O 124, such that the emulated I/O resources 124 are presented within the host environment 112 through standardized I/O interfaces. Accordingly, the emulated I/O identifier(s) may be referred to and/or may comprise I/O identifiers, I/O addresses, I/O device identifies, an I/O namespace, and/or the like. The emulated I/O resources 124 may, therefore, appear to the guest 130 to be local I/O resources 104 of a single compute node 200A-N. The emulated I/O resources 124 may map to physical I/O resources 104 of the compute nodes 200A-N through, inter alia, distributed I/O metadata 525, as disclosed herein. The emulated memory resources 126 may comprise a distributed memory space 626 that spans memory resources 106 of a plurality of the compute nodes 200A-N. The distributed memory space 626 may comprise a unitary, contiguous memory space and, as such, may appear to be the memory space of a single computing system. Memory addresses of the distributed memory space 626 may be assigned to physical memory resources 106 of particular compute nodes 200A-N through, inter alia, distributed memory metadata 625, as disclosed herein.

Step 1040 may comprise servicing computing tasks of the guest 130 through the emulated computing resources 121. Step 1040 may comprise emulating execution of instructions of the guest 130 using the emulated processor 122, emulating I/O accesses through the emulated I/O 124, emulating memory accesses through the emulated memory 126, and so on, as disclosed herein. Step 1040 may comprise distributing the computing operations to different compute nodes 200A-N in accordance with the synchronization metadata 235. Step 1040 may further comprise updating the synchronization metadata 235 in response to one or more of: a) emulating execution of an instruction, b) emulating an I/O operation, c) emulating a memory operation, and or the like.

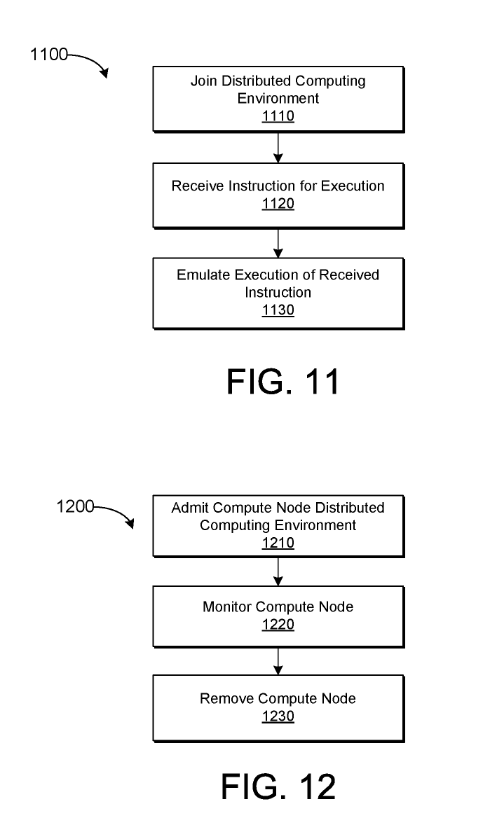

FIG. 11 is a flow diagram of other embodiment of a method for distributed computing. Step 1110 may comprise a compute node 200A-N joining the distributed computing environment 111. The distributed computing environment 111 may comprise emulated computing resources 121, such as an emulated processor 122, emulated I/O 124, emulated memory 126, emulated storage, and so on. As disclosed herein, step 1110 may comprise registering physical computing resources 101 of the compute node 200A-N as emulated computing resources 121 available within the distributed computing environment 111. Step 1110 may include registering physical processing resources 102 of the compute node 200A-N (establishing EEU 223A-N to emulate execution of instructions), registering physical I/O resources 104 of the compute node 200A-N, registering physical memory resources 106 of the compute node 200A-N, registering storage resources 108 of the compute node 200A-N, and so on. Step 1110 may comprise updating synchronization metadata 235 of the distributed computing environment 111 to present the registered resources as emulated computing resources 121 within the distributed computing environment, and to map the resources to corresponding physical computing resources 101 of the compute node 200A-N, as disclosed herein.

Step 1120 may comprise receiving an instruction for execution at the compute node 200A-N. Step 1120 may comprise receiving the instruction from another compute node 200A-N via the interconnect 115 (e.g., instruction 303N), as disclosed herein.

Step 1130 may comprise emulating execution of the received instruction. The instruction may be configured for execution by the emulated processor 122 of the distributed computing environment 111. The emulated processor 122 may emulate a single processor distributed across the compute nodes 200A-N. Step 1130 may comprise accessing distributed processor emulation metadata 225 that defines, inter alia, the architecture, configuration, and/or state of the emulated processor 122. The distributed processor emulation metadata 225 may be synchronized between the compute nodes 200A-N, such that each compute node 200A-N is configured to emulate the same instance of the same emulated processor 121.

Step 1130 may comprise assigning the instruction for execution by a particular EEU 223A-N of the compute node 200A-N. As disclosed herein, each EEU 223A-N may be assigned to a respective processing unit of the physical processing resources 102 of the compute node 200A-N. Emulating execution of the instruction 1130 may comprise modifying the distributed processor emulation metadata 225 (e.g., updating internal state metadata, such as registers, cache data, pipeline state metadata, and/or the like). Step 1130 may, therefore, further comprise synchronizing modifications to the distributed processor emulation metadata 225 (if any) to the other compute nodes 200A-N. In some embodiments, synchronizing the distributed processor emulation metadata 225 may comprise locking a portion of the distributed processor emulation metadata 225 before emulation of the instruction, updating local metadata in response to executing the instruction (and obtaining the lock), synchronizing updates to the distributed processor emulation metadata 225, and releasing the lock on the portion of the distributed processor emulation metadata 225. In some embodiments, synchronizing the distributed processor state metadata 225 comprises transmitting updates to a master compute node 200A-N, as disclosed herein. Alternatively, synchronizing the distributed processor state metadata 225 may comprise acting as the master compute node 200A-N by, inter alia, locking and/or transmitting updates to the distributed processor emulation metadata 225 through direct communication with the other compute nodes 200A-N via the interconnect (e.g. via metadata synchronization messages 237).

FIG. 12 is a flow diagram of one embodiment of a method for managing a distributed computing environment. Step 1210 may comprise admitting a compute node 200A-N into the distributed computing environment 111. As disclosed herein, step 1210 may comprise receiving a request from the compute node 200A-N to join the distributed computing environment, registering physical computing resources of the compute node 200A-N, and so on.

Step 1220 may comprise monitoring the compute node 200A-N admitted into the distributed computing environment at step 1210. Step 1220 may comprise determining performance, load, and/or health metrics of the compute node 200A-N. Step 1220 may further comprise assigning computing tasks to the compute node 200A-N, such as instructions, based on proximity, load, performance, and/or health metrics of the compute node 200A-N, as disclosed herein.

Step 1230 may comprise removing the compute node 200A-N from the distributed computing environment 111. The compute node 200A-N may be removed in response to any suitable condition or event including, but not limited to: a request to remove the compute node 200A-N, a crash, a shutdown, metrics of the compute node 200A-N (e.g., performance, health, and/or the like), and so on. Removing the compute node 200A-N may comprise de-registering physical computing resources 101 of the compute node 200A-N, such as processing resources 102, I/O resources 104, memory resources 106, storage resources 108, and/or the like. Step 1230 may, therefore, comprise updating the synchronization metadata 235 of the distributed computing environment 111 to remove (e.g., unmap) physical computing resources 101 of the compute node 200A-N. Step 1230 may further comprise transferring data, metadata, and/or state from the compute node 200A-N to one or more other compute nodes 200A-N. Step 1230 may, for example, comprise transferring the contents of the physical memory resources 106 of the compute node 200A-N to the physical memory resources 106 of another compute node 200A-N and/or reallocating addresses within the distributed memory space 626 to reference the relocated memory. Step 1230 may further comprise transferring I/O data, such as the contents of I/O buffers, mappings, and/or the like.

This disclosure has been made with reference to various exemplary embodiments. However, those skilled in the art will recognize that changes and modifications may be made to the exemplary embodiments without departing from the scope of the present disclosure. For example, various operational steps, as well as components for carrying out operational steps, may be implemented in alternative ways depending upon the particular application or in consideration of any number of cost functions associated with the operation of the system (e.g., one or more of the steps may be deleted, modified, or combined with other steps). Therefore, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Additionally, as will be appreciated by one of ordinary skill in the art, principles of the present disclosure may be reflected in a computer program product on a machine-readable storage medium having machine-readable program code means embodied in the storage medium. Any tangible, non-transitory machine-readable storage medium may be utilized, including magnetic storage devices (hard disks, floppy disks, and the like), optical storage devices (CD-ROMs, DVDs, Blu-ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a machine-readable memory that can direct a computer or other programmable data processing apparatus to function in a particular manner, such that the instructions stored in the machine-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components that are particularly adapted for a specific environment and operating requirements may be used without departing from the principles and scope of this disclosure. These and other changes or modifications are intended to be included within the scope of this disclosure.

What is claimed is:

1. A system, comprising:
a cluster comprising a plurality of computing devices, each computing device comprising a respective processor and memory and being communicatively coupled to an interconnect;
a distributed computing manager configured for operation on a first one of the plurality of computing devices, the distributed computing manager configured to manage emulated computing resources of a host computing environment, the emulated computing resources comprising an emulated processor;
a distributed execution scheduler configured to receive instructions for emulated execution on the emulated processor, and to assign the instructions to two or more of the plurality of computing devices; and
a metadata synchronization engine to synchronize an operating state of the emulated processor between the two or more computing devices during emulated execution of the instructions on the two or more computing devices.

2. The system of claim 1, wherein the distributed computing manager is configured to translate the emulated computing resources to respective physical computing resources of the computing devices in the cluster, and wherein the system further comprises:
an execution scheduler configured to assign the instructions to the two or more computing devices based on translations between the emulated computing resources referenced by the instructions and the physical computing resources of the two or more computing devices.

3-6. (canceled)

7. The system of claim 1, wherein the metadata synchronization engine is configured to synchronize distributed processor emulation metadata defining the operating state of the emulated processor between the two or more computing devices, the distributed processor emulation metadata defining one or more of: an architecture of the emulated processor, a state of a storage element of the emulated processor, a state of a register of the emulated processor, a state of a command queue of the emulated processor, a state of a processing unit of the emulated processor, and a state of a control unit of the emulated processor.

8-9. (canceled)

10. The system of claim 7, wherein the metadata synchronization engine is configured to identify a portion of the distributed processor emulation metadata to be accessed during emulated execution of an instruction assigned to a computing device of the two or more computing devices, and to lock the identified portion for access by the computing device during emulated execution of the instruction at the computing device.

11. A method, comprising
providing emulated computing resources to a guest application, wherein the emulated computing resources correspond to physical computing resources of respective compute nodes, the emulated computing resources comprising an emulated processor;
receiving instructions of the guest application for execution on the emulated processor;
assigning the instructions for execution on the emulated processor at respective compute nodes, wherein assigning an instruction to a particular compute node comprises,
identifying one or more emulated computing resources referenced by the instruction,
determining translations between the emulated computing resources referenced by the instruction and physical computing resources of the compute nodes, and
assigning the instruction to the particular compute node based on the determined translations.

12. The method of claim 11, wherein identifying the one or more emulated computing resources referenced by the instruction comprises one or more of decompiling the instruction and determining one or more opcodes corresponding to the instruction.

13. (canceled)

14. The method of claim 11, wherein the emulated computing resources referenced by the instruction comprise an address of address space of an emulated computing resource, and wherein determining the translations comprises mapping the address from the address space of the emulated computing resource to an address of a physical computing resource of one or more of the compute nodes.

15. The method of claim 11, wherein the instruction references an emulated I/O resource, and wherein determining the translations comprises translating the the referenced emulated I/O resource to a local I/O resource of one of the compute nodes.

16-17. (canceled)

18. The method of claim 11, further comprising synchronizing processor emulation metadata between the compute nodes, such that each of the compute nodes emulates instruction execution based on a synchronized operating state of the emulated processor, wherein synchronizing the processor emulation metadata comprises synchronizing one or more of register state metadata for the emulated processor, structural state metadata for the emulated processor, and control state metadata for the emulated processor.

19-25. (canceled)

26. The method of claim 18, wherein emulating execution of an instruction at a compute node comprises,
analyzing the instruction to determine a lock required to maintain consistency of the processor emulation metadata during concurrent emulation of instructions on the emulated processor by one or more other compute nodes, and
emulating execution of the instruction at the compute node in response to acquiring the determined lock.

27. (canceled)

28. The method of claim 26, wherein analyzing the instruction comprises:
pre-emulating the instruction by use of the synchronized processor emulation metadata at the compute node to identify one or more accesses to the processor emulation metadata required for emulated execution of the instruction; and
detecting one or more of a potential data hazard, a potential structural hazard, and a potential control hazard based on the one or more identified accesses, and
wherein determining the lock required to maintain consistency of the processor emulation metadata comprises determining a lock to prevent one or more of a potential data hazard, a potential structural hazard, and a potential control hazard.

29-30. (canceled)

31. A non-transitory computer-readable storage medium comprising instructions configured for execution by a processor to perform operations, comprising
providing emulated computing resources to a guest application, wherein the emulated computing resources correspond to physical computing resources of respective compute nodes, the emulated computing resources comprising an emulated processor;
receiving instructions of the guest application for execution on the emulated processor;
assigning the instructions for execution on the emulated processor at respective compute nodes, wherein assigning an instruction to a particular compute node comprises,
identifying one or more emulated computing resources referenced by the instruction,
determining translations between the emulated computing resources referenced by the instruction and physical computing resources of the compute nodes, and
assigning the instruction to the particular compute node based on the determined translations.

32. (canceled)

33. The computer-readable storage medium of claim 31, wherein identifying the one or more emulated computing resources referenced by the instruction comprises determining one or more opcodes corresponding to the instruction. 34-37. (canceled)

38. The computer-readable storage medium of claim 31, the operations further comprising synchronizing processor emulation metadata between the compute nodes, the processor emulation metadata defining one or more of a register state of the emulated processor, a structural state of the emulated processor, and a control state of the emulated processor, such that each of the compute nodes emulates instruction execution based on a synchronized operating state of the emulated processor.

39. (canceled)

40. The computer-readable storage medium of claim 38, wherein emulating execution of an instruction on the emulated processor at a compute node comprises,
identifying a portion of the processor emulation metadata to be read during emulated execution of the instruction, and
acquiring a read lock on the portion of the processor emulation metadata during emulated execution of the instruction at the compute node.

41. The computer-readable storage medium of claim 40, the operations further comprising releasing the read lock on the portion of the processor emulation metadata in response to completing the emulated execution of the instruction at the compute node.

42. The computer-readable storage medium of claim 38, wherein emulating execution of an instruction on the emulated processor at a compute node comprises,
identifying a portion of the processor emulation metadata to be modified during emulated execution of the instruction, and
acquiring a write lock on the portion of the processor emulation metadata prior to emulating execution of the instruction at the compute node.

43. The computer-readable storage medium of claim 42, the operations further comprising:
emulating execution of the instruction at the compute node in response to acquiring the write lock, wherein emulating execution of the instruction comprises generating modified processor emulation metadata at the computing node; and
releasing the write lock on the portion of the processor emulation metadata in response to one or more of: determining that the emulated execution of the instruction has been completed at the compute node, and synchronizing the modified processor emulation metadata generated at the compute node to one or more other compute nodes.

44-45. (canceled)

46. The computer-readable storage medium of claim 38, wherein emulating execution of an instruction at a compute node comprises,
analyzing the instruction to determine a lock required to maintain consistency of the processor emulation metadata during concurrent emulation of instructions on the emulated processor by one or more other compute nodes, and
emulating execution of the instruction at the compute node in response to acquiring the determined lock.

47-48. (canceled)

49. The computer-readable storage medium of claim 46 wherein analyzing the instruction comprises:
pre-emulating the instruction by use of the synchronized processor emulation metadata to identify one or more accesses to the processor emulation metadata required for emulated execution of the instruction; and
identifying one or more of a potential data hazard, a potential structural hazard, and a potential control hazard based on the one or more identified accesses.

50. The computer-readable storage medium of claim 49, wherein determining the lock required to maintain consistency of the processor emulation metadata comprises determining a lock to prevent one or more of a potential data hazard, a potential structural hazard, and a potential control hazard.
